(19) United States
(12) Patent Application Publication
(10) Pub. No.: US 2009/0084673 A1
(43) Pub. Date: Apr. 2, 2009

(54) GAS SENSOR ELEMENT AND METHOD FOR MANUFACTURING SAME

(75) Inventors: Itsuhei Ogata, Okazaki-shi (JP); Daisuke Makino, Ichinomiya-shi (JP); Satoshi Nakamura, Okazaki-shi (JP); Hiroo Imamura, Nukata-gun (JP); Akio Tanaka, Gifu-shi (JP)

Correspondence Address: NIXON & VANDERHYE, PC, 901 NORTH GLEBE ROAD, 11TH FLOOR, ARLINGTON, VA, 22203, US

(73) Assignees: DENSO CORPORATION, Kariya-city, Aichi-pref. (JP); NIPPON SOKEN, INC., Nishio-city, Aichi-pref. (JP)

(21) Appl. No.: 11/994,093

(22) PCT Filed: Jun. 29, 2006
(86) PCT No.: PCT/JP2006/312968

§ 371 Date: Dec. 27, 2007

(30) Foreign Application Priority Data
Jun. 30, 2005 (JP) 2005-191358
Apr. 5, 2006 (JP) 2006-104354
Jun. 16, 2006 (JP) 2006-167060

(51) Int. Cl. C04B 35/48

(52) U.S. Cl. 204/243.1; 427/58; 427/569; 977/957

(57) ABSTRACT

There is described a gas sensor element 1 including a solid electrolyte body 11, insulators 15, 141, 142, 197, 161, 162, 163, 164, 165, and a pair of electrodes 121, 131 formed such that the solid electrolyte body 11 is held therebetween. The gas sensor element 1 satisfies the following requirement (a) and/or the requirement (b). (a) The solid electrolyte body 11 is made of ion-conductive composite material in which nanoparticles with specific particle diameters are dispersed in ion-conductive ceramics. (b) The insulators 15, 141, 197, 161, 162, 163, 164, 165 are made of insulative composite material in which nanoparticles with specific particle diameters are dispersed in insulative ceramics. Further, there is described a manufacturing method of a gas sensor element in which the particle diameter and dispersion quantity of the nanoparticles dispersed in the solid electrolyte body 11 and/or insulative ceramics 11 are controlled.

### TECHNICAL FIELD

The present invention relates to a gas sensor element that can be used for combustion control of an internal combustion engine such as a vehicle engine, and a method of manufacturing same.

### BACKGROUND ART

In an exhaust system of a vehicle internal combustion engine etc. there is used a gas sensor element such as an O2 sensor element, a NOₓ sensor element, and an A/F sensor element in order to detect O2 concentration, NOₓ concentration, air-fuel ratio, etc., contained in an exhaust gas or the like. As such a gas sensor element, there is used a cup-shaped or a laminated-type element including a solid electrolyte body having ion conductivity, an insulator having electrical insulation property, and electrodes.

Usually, a gas sensor element located in an exhaust gas undergoes various stresses. For example, if the gas sensor element is activated rapidly, the temperature of the gas sensor element increases rapidly, and as a results stress occurs in the gas sensor element. Also if the gas sensor element is flooded by water vapor contained in the exhaust gas or atmospheric air, stress occurs in the gas sensor element. And also, if the temperature or flow velocity of the exhaust gas increases rapidly, stress occurs in the gas sensor element.

If the stress occurred as above in the gas sensor element exceeds an allowable value, a fracture may occur in the solid electrolyte body or the insulator of the gas sensor element, causing the gas sensor element to be unable to accurately detect O2 concentration, NOₓ concentration, air-fuel ratio, etc., and therefore causing its reliability to be lowered.

Heretofore, it has been done to cover the gas sensor element by a protection cover to lessen the stress to the gas sensor element. However, it has been difficult to sufficiently reduce the stress applied to the gas sensor element even by use of the protection cover. Especially, the stress due to flooding is caused by moisture contained in a gas such as an exhaust gas, a reference gas, and atmospheric air, with which it is difficult for the gas sensor element to avoid from directly contacting. Accordingly, it has been difficult to reduce the stress even by use of the protection cover.

Incidentally, there is being developed a zirconia-based composite ceramics sintered body in which Al2O3 particles with an average diameter not larger than 2 μm are dispersed in partially stabilized zirconia with an average particle diameter not larger than 5 μm (refer to Patent Document 1). Such a zirconia-based composite ceramics can exhibit high strength. It can be thought that if such a zirconia-based composite ceramics sintered body is applied to the gas sensor element, a gas sensor element that shows high resistance to stress can be obtained.

Patent Document 1: Patent No. 2703207

### DISCLOSURE OF THE INVENTION

### Problems to be Solved by the Invention

However, requirement to the gas sensor element is not limited to strength, but the solid electrolyte body is required to have ion conductivity property, and the insulator is required to have electrical insulating property. If such properties are not satisfied, it might occur that it does not function as a gas sensor element even if it has high strength.

The present invention has been made in view of such conventional problems with an object to provide a reliable gas sensor element that shows excellent resistance to large stress such as stress occurred when flooded, and a method of manufacturing same.

### Means for Solving the Problems

The first invention is in a gas sensor element (claim 1) comprising a solid electrolyte body consisting primarily of ion-conductive ceramics, an insulator consisting primarily of insulative ceramics, and a pair of electrodes formed such that at least a part of the solid electrolyte body is held therebetween, and satisfying at least one of the following requirements (a) and (b).

(a) At least a part of the solid electrolyte body is made of ion-conductive composite material in which nanoparticles with a particle diameter equal to or smaller than 100 nm are dispersed in a principal component composed of the ion-conductive ceramics by 0.1-20 weight %.

(b) At least a part of the insulator is made of insulative composite material in which nanoparticles with a particle diameter equal to or smaller than 100 nm are dispersed in a principal component composed of the insulative ceramics by 0.1-20 weight %.

The gas sensor element satisfies the requirement (a) and/or the requirement (b).

In a case where the requirement (a) is satisfied, that is, in a case where at least a part of the solid electrolyte body is made of the ion-conductive composite material, the solid electrolyte body can withstand large stress exceeding 350 MPa, for example, and can exhibit excellent strength. Further, in the ion-conductive composite material, a specific quantity of 0.1-20 weight % of the nanoparticles are dispersed in the principal component composed of the ion-conductive ceramics. Accordingly, even in a case where the nanoparticles are made of insulative material, the solid electrolyte body can assure conductivity sufficiently.

Further, in a case where the requirement (b) is satisfied, that is, in a case where at least a part of the insulator is made of the insulative composite material, the insulator can withstand large stress exceeding 350 MPa, and can exhibit excellent strength.

Further, in the insulative composite material, a specific quantity of 0.1-20 weight % of the nanoparticles are dispersed in the principal component composed of the insulative ceramics. Accordingly, even in a case where the nanoparticles are made of conductive material, the insulator can assure insulativity sufficiently.

In a case where the gas sensor element satisfies both the requirement (a) and the requirement (b), the solid electrolyte body made of the ion-conductive composite material, and the insulator made of the insulative composite material can exhibit excellent strength as described above, and in addition, conductivity of the solid electrolyte body and insulativity of the insulator can be assured sufficiently.

Accordingly, the gas sensor element can exhibit excellent strength, while assuring a function as a gas sensor element. Hence, even when a large stress is applied to the gas sensor elements, it is possible to prevent a breakage such as a fracture from occurring in the gas sensor element, and perform accurate detection.

Generally, as stress that can be applied to the gas sensor element, there is a stress that occurs due to rapid temperature increase on early activation, a stress that occurs when the temperature or flow velocity of an exhaust gas rapidly changes, and a stress that occurs in case of flooding.

The stress that occurs in case of flooding is largest in a vehicle-mounted condition according to estimation of these stresses by simulation. The stress occurring due to flooding increases in accordance with a flood volume, and the occurring stress saturates and reaches a maximum value (largest occurring stress) when the flood volume exceeds a certain extent (see FIG. 11). Accordingly, by use of a solid electrolyte body and/or a insulator having strength beyond this largest occurring stress, it is possible to prevent fracture of the solid electrolyte body and/or the insulator.

In the gas sensor element of the invention, as described above, the solid electrolyte body satisfying the requirement (a) and/or the insulator satisfying the requirement (b) are used. Accordingly, the solid electrolyte body and/or the insulator can exhibit strength beyond the large stress in case of flooding to prevent occurrence of fracture.

The second invention is in a method of manufacturing a gas sensor element including a solid electrolyte body made of ion-conductive composite material in which nanoparticles with a particle diameter equal to or smaller than 100 nm are dispersed in a principal component composed of ion-conductive ceramics by 0.1-20 weight %, an insulator consisting primarily of insulative ceramics, and a pair of electrodes formed such that at least a part of the solid electrolyte body is held therebetween, said method comprising:

a nanoslurry preparation step of preparing nanoparticle slurry by dispersing nanoparticles with a particle diameter equal to or smaller than 100 nm in a solvent;

an ion-conductive slurry preparation step of preparing ion-conductive ceramics slurry by dispersing ion-conductive ceramics in a solvent;

an ion-conductive composite material preparation step of preparing ion-conductive composite material slurry by mixing the nanoparticle slurry and the ion-conductive ceramics slurry at a mixing ratio of 0.1-20 weight parts of the nanoparticles to 100 parts of a total of the nanoparticles and the ion-conductive ceramics;

an ion-conductive composite material forming step of making an ion-conductive composite material compact by forming the ion-conductive composite material slurry;

an electrode print section forming step of forming a pair of electrode print sections such that at least a part of the ion-conductive composite material compact is held therebetween;

an insulative slurry preparation step of preparing insulative ceramics slurry by dispersing insulative ceramics in a solvent;

an insulative ceramics forming step of making an insulative ceramics compact by forming the insulative ceramics slurry; and

a baking step of making the gas sensor element by integrally baking the ion-conductive composite material compact and the insulative ceramics compact (claim 6).

The third invention is in a method of manufacturing a gas sensor element including a solid electrolyte body made of ion-conductive composite material in which nanoparticles with a particle diameter equal to or smaller than 100 nm are dispersed in a principal component composed of ion-conductive ceramics by 0.1-20 weight %, an insulator consisting primarily of insulative ceramics, and a pair of electrodes formed such that at least a part of the solid electrolyte body is held therebetween, said method comprising:

a nanoslurry preparation step of preparing nanoparticle slurry by dispersing nanoparticles with a particle diameter equal to or smaller than 100 nm in a solvent;

an ion-conductive slurry preparation step of preparing ion-conductive ceramics slurry by dispersing ion-conductive ceramics in a solvent;

an ion-conductive composite material preparation step of preparing ion-conductive composite material slurry by mixing the nanoparticle slurry and the ion-conductive ceramics slurry at a mixing ratio of 0.1-20 weight parts of the nanoparticles to 100 parts of a total of the nanoparticles and the ion-conductive ceramics;

an ion-conductive composite material forming step of making an ion-conductive composite material compact by forming the on-conductive composite material slurry;

a baking step of making the solid electrolyte body by baking the ion-conductive composite material compact;

an electrode forming step of forming a pair of electrodes such that at least a part of the solid electrolyte body is held therebetween;

an insulative slurry preparation step of preparing insulative ceramics slurry by dispersing insulative ceramics in a solvent; and

an insulative ceramics body forming step of forming an insulative ceramics body integrally with the solid electrolyte body by baking the insulative ceramics slurry onto the solid electrolyte body, or by plasma-spraying the insulative ceramics slurry onto the solid electrolyte body (claim 7).

The fourth invention is in a method of manufacturing a gas sensor element including a solid electrolyte body consisting primarily of ion-conductive ceramics, an insulator made of an insulative composite material in which nanoparticles with a particle diameter equal to or smaller than 100 nm are dispersed in a principal component composed of ion-conductive ceramics by 0.1-20 weight %, and a pair of electrodes formed such that at least a part of the solid electrolyte body is held therebetween, said method comprising:

an ion-conductive slurry preparation step of preparing ion-conductive ceramics slurry by dispersing ion-conductive ceramics in a solvent;

an ion-conductive ceramics slurry forming step of making an ion-conductive ceramics compact by forming the ion-conductive ceramics slurry;

an electrode print section forming step of forming a pair of electrode print sections such that at least a part of the ion-conductive ceramics compact is held therebetween;

a nanoslurry preparation step of preparing nanoparticle slurry by dispersing nanoparticles with a particle diameter equal to or smaller than 100 nm in a solvent;

an insulative slurry preparation step of preparing insulative ceramics slurry by dispersing insulative ceramics in a solvent;

an insulative composite material preparation step of preparing insulative composite material slurry by mixing the nanoparticle slurry and the insulative ceramics slurry at a mixing ratio of 0.1-20 weight parts of the nanoparticles to 100 parts of a total of the nanoparticles and the insulative ceramics;

an insulative composite material forming step of making an insulative composite material compact by forming the insulative composite material slurry; and

a baking step of making the gas sensor element by integrally baking the ion-conductive ceramics compact and the insulative composite material compact (claim 13).

The fifth invention is in a method of manufacturing a gas sensor element including a solid electrolyte body consisting primarily of ion-conductive ceramics, an insulator made of an insulative composite material in which nanoparticles with a particle diameter equal to or smaller than 100 nm are dispersed in a principal component composed of insulative ceramics by 0.1-20 weight %, and a pair of electrodes formed such that at least a part of the solid electrolyte body is held therebetween, said method comprising:

an ion-conductive slurry preparation step of preparing ion-conductive ceramics slurry by dispersing ion-conductive ceramics in a solvent;

an ion-conductive ceramics forming step of making an ion-conductive ceramics compact by forming the ion-conductive ceramics slurry;

a baking step of making the solid electrolyte body by baking the ion-conductive ceramics compact;

an electrode forming step of forming a pair of electrodes such that at least a part of the solid electrolyte body is held therebetween;

a nanoslurry preparation step of preparing nanoparticle slurry by dispersing nanoparticles with a particle diameter equal to or smaller than 100 nm in a solvent;

an insulative slurry preparation step of preparing insulative ceramics slurry by dispersing insulative ceramics in a solvent;

an insulative composite material preparation step of preparing insulative composite material slurry by mixing the nanoparticle slurry and the insulative ceramics slurry at a mixing ratio of 0.1-20 weight parts of the nanoparticles to 100 parts of a total of the nanoparticles and the insulative ceramics; and

an insulative ceramics body forming step of forming an insulative ceramics body integrally with the solid electrolyte body by burning the insulative composite material slurry on the solid electrolyte body, or by plasma-spraying the insulative composite material ceramics slurry on the solid electrolyte body (claim 14).

The sixth invention is in a method of manufacturing a gas sensor element including a solid electrolyte body made of an ion-conductive composite material in which nanoparticles with a particle diameter equal to or smaller than 100 nm are dispersed in a principal component composed of ion-conductive ceramics by 0.1-20 weight %, and a pair of electrodes formed such that at least a part of the solid electrolyte body is held therebetween, said method comprising:

a first nanoslurry preparation step of preparing a first nanoparticle slurry by dispersing first nanoparticles with a particle diameter equal to or smaller than 100 nm in a solvent;

an ion-conductive slurry preparation step of preparing ion-conductive ceramics slurry by dispersing ion-conductive ceramics in a solvent;

an ion-conductive composite material preparation step of preparing ion-conductive composite material slurry by mixing the first nanoparticle slurry and the ion-conductive ceramics slurry at a mixing ratio of 0.1-20 weight parts of the first nanoparticles to 100 parts of a total of the first nanoparticles and the ion-conductive ceramics;

an ion-conductive composite material forming step of making an ion-conductive composite material compact by forming the ion-conductive composite material slurry;

an electrode print section forming step of forming a pair of electrode print sections such that at least a part of the ion-conductive composite material compact is held therebetween;

a second nanoslurry preparation step of preparing a second nanoparticle slurry by dispersing second nanoparticles with a particle diameter equal to or smaller than 100 nm in a solvent;

an insulative slurry preparation step of preparing insulative ceramics slurry by dispersing insulative ceramics in a solvent;

an insulative composite material preparation step of preparing insulative composite material slurry by mixing the second nanoparticle slurry and the insulative ceramics slurry at a mixing ratio of 0.1-20 weight parts of the second nanoparticles to 100 parts of a total of the second nanoparticles and the insulative ceramics;

an insulative composite material forming step of making an insulative composite material compact by forming the insulative composite material slurry; and

a baking step of making the gas sensor element by integrally baking the ion-conductive composite material compact and the insulative composite material compact (claim 20).

The seventh invention is in a method of manufacturing a gas sensor element including a solid electrolyte body made of an ion-conductive composite material in which first nanoparticles with a particle diameter equal to or smaller than 100 nm are dispersed in a principal component composed of ion-conductive ceramics by 0.1-20 weight %, an insulator made of insulative composite material in which second nanoparticles with a diameter equal to or smaller than 100 nm are dispersed in a principal component composed of insulative ceramics by 0.1-20 weight %, and a pair of electrodes formed such that at least a part of the solid electrolyte body is held therebetween, said method comprising:

a first nanoslurry preparation step of preparing first nanoparticle slurry by dispersing first nanoparticles with a particle diameter equal to or smaller than 100 nm in a solvent;

an ion-conductive slurry preparation step of preparing ion-conductive ceramics slurry by dispersing ion-conductive ceramics in a solvent;

an ion-conductive composite material preparation step of preparing ion-conductive composite material slurry by mixing the first nanoparticle slurry and the ion-conductive ceramics slurry at a mixing ratio of 0.1-20 weight parts of the first nanoparticles to 100 parts of a total of the first nanoparticles and the ion-conductive ceramics;

an ion-conductive composite material forming step of making an ion-conductive composite material compact by forming the on-conductive composite material slurry;

a baking step of making the solid electrolyte body by baking the ion-conductive composite material compact;

an electrode forming step of forming a pair of electrodes such that at least a part of the solid electrolyte body is held therebetween;

a second nanoslurry preparation step of preparing second nanoparticle slurry by dispersing second nanoparticles with a particle diameter equal to or smaller than 100 nm in a solvent;

an insulative slurry preparation step of preparing insulative ceramics slurry by dispersing insulative ceramics in a solvent;

an insulative composite material preparation step of preparing insulative composite material slurry by mixing the second nanoparticle slurry and the insulative ceramics slurry at a mixing ratio of 0.1-20 weight parts of the second nanoparticles to 100 parts of a total of the second nanoparticles and the insulative ceramics; and

an insulative ceramics body forming step of forming an insulative ceramics body integrally with the solid electrolyte body by baking the insulative composite material slurry onto the solid electrolyte body, or by plasma-spraying the insulative composite material slurry onto the solid electrolyte body (claim 21).

The most remarkable point in the second to seventh inventions is in that nanoparticles with a specific particle diameter, ion-conductive ceramics, and/or insulative ceramics are mixed with a specific mixing ratio.

That is, in the second and third inventions, the nanoparticle slurry containing nanoparticles with a particle diameter equal to or smaller than 100 nm and the ion-conductive ceramics slurry are mixed at a mixing ratio of 0.1-20 weight parts of the nanoparticles to 100 parts of a total of the nanoparticles and the ion-conductive ceramics (the ion-conductive composite material preparation step).

Further, in the fourth and fifth inventions, the nanoparticle slurry containing nanoparticles with a particle diameter equal to or smaller than 100 nm and the insulative ceramics slurry are mixed at a mixing ratio of 0.1-20 weight parts of the nanoparticles to 100 parts of a total of the nanoparticles and the insulative ceramics (the insulative composite material preparation step).

Further, in the sixth and seventh inventions, the ion-conductive composite material preparation step and the insulative composite material preparation step are performed.

As a result, according to the manufacturing methods of the second to seventh inventions, the gas sensor element of the first invention can be manufactured.

To be more precise, according to the second and third inventions, the gas sensor element satisfying the requirement (a) of the first invention can be manufactured.

According to the fourth and fifth inventions, the gas sensor element satisfying the requirement (b) of the first invention can be manufactured.

Further, according to the sixth and seventh inventions, the gas sensor element satisfying the requirement (a) and the requirement (b) of the first invention can be manufactured.

As above, according to the second to fourth inventions, the gas sensor element of the first invention, which can show excellent resistance to large stress such as a stress occurred when flooded, and is excellent in reliability can be manufactured.

### BRIEF DESCRIPTION OF THE DRAWING

FIG. 1 is a perspective development view of a gas sensor element of embodiment 1.

FIG. 2 is a perspective view of the gas sensor element of embodiment 1.

FIG. 3 is a substantial part cross-sectional view of the gas sensor element of embodiment 1.

FIG. 4 is an explanatory view showing an overall structure of a high-pressure dispersion apparatus of the embodiment 1.

FIG. 5 is an explanatory view showing a structure of a mixing dispersion section of the high-pressure dispersion apparatus of embodiment 1.

FIG. 6 is an explanatory view showing a cross section of a gas sensor element of embodiment 2.

FIG. 7 is an explanatory view of a gas sensor incorporating the gas sensor element of embodiment 2.

FIG. 8 is an explanatory view showing an overall structure of a high-speed shearing mixer of embodiment 2.

FIG. 9 is an explanatory view showing a structure of a closed pressure-resistant container of the high-speed shearing mixer of embodiment 2.

FIG. 10 is an explanatory view showing a method of a transverse rupture strength test for experiment examples.

FIG. 11 is a diagrammatic view showing a relationship between a flood volume of the gas sensor element in a vehicle-mounted condition, and occurring stress.

FIG. 12 is a perspective development view of a gas sensor element of embodiment 3.

### EXPLANATION OF LETTERS AND NUMERALS

1 gas sensor element
10 nanoparticles
11 solid electrolyte body
121 electrode (measured gas side electrode)
131 electrode (reference electrode)
141 insulator (diffusion layer)
15 insulator (reference gas chamber forming plate)

### BEST MODE TO PRACTICE THE INVENTION

Next, explanation is made as to preferred embodiments of the gas sensor element of the present invention.

The gas sensor element satisfies the requirement (a) and/or the requirement (b).

The requirement (a) is that at least a part of the solid electrolyte body is made of ion-conductive composite material in which nanoparticles with a particle diameter equal to or smaller than 100 nm are dispersed in a principal component composed of ion-conductive ceramics by 0.1-20 weight %.

The requirement (b) is that at least a part of the insulator is made of insulative composite material in which nanoparticles with a particle diameter equal to or smaller than 100 nm are dispersed in a principal component composed of the insulative ceramics by 0.1-20 weight %.

In case the particle diameter exceeds 100 nm, the strength of the solid electrolyte body and the insulator may be lowered.

Accordingly, in that case, if the gas sensor element undergoes a stress exceeding an allowable value due to flooding or the like, there may occur a fracture or the like in the gas sensor element causing the gas sensor element to be unable to perform correct detection.

Further, in case the dispersion quantity of the nanoparticles is less than 0.1 weight %, the effect of strength improvement is not obtained sufficiently, and there may occur a fracture or the like due to flooding. On the other hand, in case the dispersion quantity of the nanoparticles exceeds 20 weight %, and the nanoparticles are made of insulative material, the ion-conductivity of the solid electrolyte body is lowered, and the gas sensor element may malfunction. On the other hand, in case the diffusion quantity of the nanoparticles exceeds 20 weight %, and the nanoparticles are made of a conductive material, the insulativity of the insulator is lowered, and the gas sensor element may malfunction.

It is preferable that the gas sensor element satisfies both the requirement (a) and the requirement (b).

In that case, since the strength improves in both the solid electrolyte body and the insulator, the reliability of the gas sensor element further improves, and it is possible to more suppress the occurrence of a fracture or the like due to flooding.

Further, the gas sensor element may have the solid electrolyte body singly or plurally.

In case it has a plurality of the solid electrolyte bodies, at least one may be formed by the ion-conductive composite material.

Further, like the solid electrolyte body, the gas sensor element may have the insulator singly or plurally. In case it has a plurality of the insulators, at least one may be formed by the insulative composite material.

Further, the solid electrolyte body consists primarily of ion-conductive ceramics.

For example, as the ion-conductive ceramics, there are zirconia, partially stabilized zirconia, stabilized zirconia, ceria, gadolinium, ceria acid strontium, zirconic acid strontium, ceria acid barium, zirconic acid barium, etc.

Further, the insulator consists primarily of insulative ceramics.

For example, as the insulative ceramics, there are alumina, silica, aluminium nitride, silicon nitride, etc.

Preferably, the ion-conductive ceramics is made of partially stabilized zirconia in which a stabilizer is added to a principal component composed of zirconia, and the insulative ceramics is made of alumina (claim 2).

In this case, the ion-conductive ceramics and the insulative ceramics form a chemically stable combination, and can exhibit a stable characteristic even when used in an environment that can be an oxidizing atmosphere and a reducing atmosphere.

Generally, a material in which a stabilizer such as magnesia (magnesium oxide), calcium oxide, yttria (yttrium oxide), cerium oxide, titanium oxide, a rare earth oxide, etc. is added to zirconia (zirconium oxide) by several mol % takes a fluorite structure of cubic system, and does not exhibit phase transition. This is a stabilized zirconia. The partially stabilized zirconia is zirconia whose composition is stabilized in part.

As the nanoparticles, ones made of a material like the ion-conductive ceramics or the insulative ceramics may be used.

Preferably, the nanoparticles are made of one or more kinds selected from alumina, zirconia, partially stabilized zirconia, and the stabilizer (claim 3).

In this case, since the constituent material is chemically stable, the state of dispersion in the particles and to the particle boundary is good, and the ion-conductive composite material and the insulated composite material can be formed by the same elements as the constituent elements of the gas sensor element, it is possible to prevent aged deterioration etc. due to reaction between different elements.

Further, it is preferable that the solid electrolyte body is made of the ion-conductive composite material in which the nanoparticles made of alumina are dispersed in the ion-conductive ceramics made of partially stabilized zirconia, and the insulator is made of the insulative composite material in which the nanoparticles made of one or more kinds selected from zirconia, partially stabilized zirconia, and the stabilizer are dispersed in the insulative ceramics made of alumina.

In this case, since the solid electrolyte body and the insulator include the same elements, it is possible to put the solid electrolyte body and the insulator in a good junction state in case the solid electrolyte body and the insulator are laminated to constitute the gas sensor element, for example.

Further, in the gas sensor element, it is preferable that at least the solid electrolyte body located at a position to be in contact with a gas introduced into the gas sensor element, or atmospheric air is made of the ion-conductive composite material (claim 4).

In this case, it is possible to improve the strength of the solid electrolyte body located at a portion which is easily flooded. That is, the solid electrolyte body, which contacts a gas such as an exhaust gas, a reference gas, and atmospheric air, is easily flooded by moisture contained in the gas. By forming this solid electrolyte body, which is easily flooded, by the ion-conductive composite material, it is possible to surely prevent the solid electrolyte body from being damaged by flooding.

Further, in the gas sensor element, it is preferable that at least the insulator located at a position to be in contact with a gas introduced into the gas sensor element, or atmospheric air is made of the insulative composite material (claim 5).

In this case, it is possible to improve the strength of the insulator located at a portion which is easily flooded. That is, the insulator, which contacts a gas such as the exhaust gas, reference gas, and atmospheric air, is easily flooded by moisture contained in the gas. By forming this insulator, which is easily flooded, by the insulated composite material, it is possible to surely prevent the insulator from being damaged by flooding.

The gas sensor element can be applied to an 02 sensor element, an NOₓ sensor element, an HC sensor element, a CO sensor element, an A/F sensor element, and a composite gas sensor element capable of detecting plural kinds of gas concentrations, for example.

Further, the gas sensor element can be applied to a laminated type element which is structured by laminating a plate-like solid electrolyte body and a pate-like insulator, or a cup-shaped element having a solid electrotype body of a bottomed cylinder shape, etc.

Next, in the second invention, there are performed the nanoslurry preparation step, ion-conductive slurry preparation step, ion-conductive composite material preparation step, ion-conductive composite material forming step, electrode print section forming step, insulative slurry preparation step, insulative ceramics forming step, and baking step.

In the nanoslurry preparation step, nanoslurry is prepared by dispersing nanoparticles with a particle diameter equal to or smaller than 100 nm in a solvent.

In case the particle diameter exceeds 100 nm, the strength of the solid electrolyte body of the finally obtainable gas sensor element may be lowered.

As the nanoparticles, ones made of a material like the ion-conductive ceramics or the insulative ceramics may be used as in the case of the first invention. Preferably, the nanoparticles are made of one or more kinds selected from alumina, zirconia, partially stabilized zirconia, and the stabilizer.

In the ion-conductive slurry preparation step, ion-conductive ceramics slurry is prepared by dispersing ion-conductive ceramics in a solvent.

As the ion-conductive ceramics, as in the first invention, there may be used zirconia, partially stabilized zirconia, stabilized zirconia, ceria, gadolinium, ceria acid strontium, zirconic acid strontium, ceria acid barium, zirconic acid barium, etc.

Preferably, the partially stabilized zirconia in which the stabilizer is added to a principal component composed of zirconia is good.

Further, the insulative slurry preparation step prepares insulative ceramics slurry by dispersing insulative ceramics in a solvent.

As the insulative ceramics, as in the first invention, there are alumina, silica, aluminium nitride, silicon nitride, etc., for example. Preferably, alumina is good.

Further, in the ion-conductive composite material preparation step, the nanoparticle slurry and the ion-conductive ceramics slurry are mixed at a mixing ratio of 0.1-20 weight parts of the nanoparticles to 100 parts of a total of the nanoparticles and the ion-conductive ceramics. By this, there can be obtained ion-conductive composite material slurry in which the ionic conduction ceramics and the nanoparticles are dispersed in the solvent.

In case the nanoparticles is less than 0.1 weight parts the effect of strength improvement by the nanoparticles is not obtained sufficiently in the finally obtainable gas sensor element, and there may occur a fracture or the like due to flooding. On the other hand, in case of exceeding 20 weight parts, the ion conductivity of the solid electrolyte body is lowered, and the gas sensor element may malfunction.

In the ion-conductive composite material forming step, an ion-conductive composite material compact is made by forming the ion-conductive composite material slurry.

Further, in the insulative ceramics forming step, an insulative ceramics compact is made by forming the insulative ceramics slurry.

The forming may be performed by the doctor blade method, extrusion molding, injection molding, cutting fabrication, press molding, laminating fabrication, etc.

In the electrode print step, a pair of electrode print sections are formed such that at least a part of the ion-conductive composite material compact is held therebetween. To be more precise, the electrode print sections can be formed by printing metal paste obtained by diffusing conductive metal such as platinum etc. in a solvent.

Further, in the baking step, the ion-conductive composite compact and the insulative ceramics compact are baked integrally. In the baking step, baking can be performed by heating at a temperature of 1400-1550° C.

In this way, there can be obtained the gas sensor element including a solid electrolyte body consisting primarily of ion-conductive ceramics, an insulator consisting primarily of insulative ceramics, and a pair of electrodes formed such that at least a part of the solid electrolyte body is held therebetween. In the gas sensor element obtained by the second invention, at least a part of the solid electrolyte body is made of ion-conductive composite material in which nanoparticles with a particle diameter equal to or smaller than 10 nm are dispersed in a principal component composed of the insulative ceramics by 0.1-20 weight %.

Next, in the third invention, to manufacture the gas sensor element, there are performed the nanoslurry preparation step, ion-conductive slurry preparation step, ion-conductive composite material preparation step, ion-conductive composite material forming step, baking step, electrode forming step, insulative slurry preparation step, and insulative ceramics body forming step.

In the third invention, the nanoslurry preparation step, ion-conductive slurry preparation step, ion-conductive composite material preparation step, ion-conductive composite material forming step, and insulative slurry preparation step are the steps similar to each of the steps of the second invention.

In the baking step of the third invention, the solid electrolyte body is made by baking the ion-conductive composite material compact. The baking of the ion-conductive composite material compact may be performed by heating at a temperature of 1400-1550° C., for example.

In the electrode forming step, a pair of electrodes are formed such that at least a part of the solid electrolyte body is held therebetween. To be more precise, the electrodes can be formed by depositing conductive metal on the solid electrolyte body by surface treatment such as plating etc.

Further, in the insulative ceramics body forming step, an insulative ceramics body is formed integrally with the solid electrolyte body by baking the insulative ceramics slurry onto the solid electrolyte body, or by plasma-spraying the insulative ceramics slurry onto the solid electrolyte body.

As above, in the third invention, as in the second invention, there can be obtained a gas sensor element including a solid electrolyte body made of ion-conductive composite material in which nanoparticles with a particle diameter equal to or smaller than 100 nm are dispersed in a principal component composed of the ion-conductive ceramics by 0.1-20 weight %, an insulator consisting primarily of insulative ceramics, and a pair of electrodes formed such that at least a part of the solid electrolyte body is held therebetween.

Next, in the fourth invention, the gas sensor element is manufactured by performing the ion-conductive slurry preparation step, nanoslurry preparation step, insulative slurry preparation step, insulative composite material preparation step, ion-conductive ceramics forming step, insulative composite material forming step, electrode print section forming step, and baking step.

In the fourth invention, the nanoslurry preparation step, ion-conductive slurry preparation step, and insulative slurry preparation step are steps similar to each of the steps of the second invention.

Further, in the insulative composite material preparation step, the nanoparticle slurry and the insulative ceramics slurry are mixed at a mixing ratio of 0.1-20 weight parts of the nanoparticles to 100 parts of a total of the nanoparticles and the insulative ceramics. By this, the insulative composite material slurry in which nanoparticles slurry and insulative ceramics slurry are dispersed in a solvent can be obtained.

In case the nanoparticles is less than 0.1 weight parts, the effect of strength improvement by the nanoparticles is not obtained sufficiently in the finally obtainable gas sensor element, and there may occur a fracture or the like due to flooding, as described above. On the other hand, in case of exceeding 20 weight part, the insulativity of the insulator is lowered, and the gas sensor element may malfunction.

In the ion-conductive ceramics forming step, an ion-conductive ceramics compact is made by forming the ion-conductive ceramics slurry.

Further, in the insulative composite material forming step, an insulative composite material compact is made by forming the insulative composite material slurry.

As in the second invention, these formings may be performed by the doctor blade method, extrusion molding, injection molding, cutting fabrication, press molding, laminating fabrication, etc.

In the electrode print step, a pair of electrode print sections are formed such that at least a part of the ion-conductive ceramics compact is held therebetween. The forming of the electrode print section can be performed in the same way as in the second invention.

Further, in the baking step, the ion-conductive ceramics compact and the insulative composite material compact are baked integrally. In the baking step, baking can be performed by heating at a temperature of 1400-1550° C.

In this way, there can be obtained a gas sensor element including a solid electrolyte body consisting primarily of ion-conductive ceramics, an insulator consisting primarily of insulative ceramics, and a pair of electrodes formed such that at least a part of the solid electrolyte body is held therebetween. In the gas sensor element obtained by the fourth invention, at least a part of the insulator is made of insulative composite material in which nanoparticles with a particle diameter equal to or smaller than 100 nm are dispersed in a principal component composed of the insulative ceramics by 0.1-20 weight %.

Next, in the fifth invention, to manufacture the gas sensor element, there are performed the ion-conductive slurry preparation step, ion-conductive ceramics forming step, baking step, electrode forming step, nanoslurry preparation step, insulative slurry preparation step, insulative composite material preparation step, and insulative ceramics body forming step.

In the fifth invention, the nanoslurry preparation step, ion-conductive slurry preparation step, and insulative slurry preparation step are steps similar to each of the steps of the second invention.

Further, the insulative composite material preparation step, and ion-conductive ceramics forming step are steps similar to each of the steps of the fourth invention. Further, the electrode forming step is a step similar to such step in the third invention.

In the baking step, the solid electrolyte body is made by baking the ion-conductive ceramics compact at a temperature of 1400-1550° C.

Further, in the insulative ceramics body forming step in the fifth invention, an insulative ceramics body is formed integrally with the solid electrolyte body by baking the insulative composite material slurry onto the solid electrolyte body, or by plasma-spraying the insulative composite material slurry onto the solid electrolyte body.

In this way, as in the fourth invention, in the fifth invention, there can be obtained a gas sensor element including a solid electrolyte body consisting primarily of ion-conductive ceramics, an insulator made of an insulative composite material in which nanoparticles with a particle diameter equal to or smaller than 100 nm are dispersed in a principal component composed of insulative ceramics by 0.1-20 weight %, and a pair of electrodes formed such that at least a part of the solid electrolyte body is held therebetween.

Next, in the sixth invention, the gas sensor element is manufactured by performing the first nanoslurry preparation step, ion-conductive slurry preparation step, insulative slurry preparation step, second nanoslurry preparation step, ion-conductive composite material preparation step, insulative composite material preparation step, ion-conductive composite material forming step, insulative composite material forming step, electrode print section forming step, and baking step

In the sixth invention, the first nanoslurry preparation step, ion-conductive slurry preparation step, insulative slurry preparation step, and second nanoslurry preparation step are steps similar to each of the steps of the second invention. The first nanoslurry preparation step and the second nanoslurry preparation step are described separately for the sake of convenience of description, however, they are a step substantially the same as the nanoslurry preparation step in the second invention, that is, a step for dispersing nanoparticles in a solvent.

Further, the ion-conductive composite material preparation step is a step similar with the second invention, and the insulative composite material preparation step is a step similar with the fourth invention.

The first nanoparticle slurry in the first nanoslurry preparation step is nanoparticle slurry to be mixed with the ion-conductive ceramics slurry. On the other hand, the second nanoparticle slurry in the second nanoslurry preparation step is nanoparticle slurry to be mixed with the insulative ceramics slurry.

As described above, it is preferable that matter made of one or more kinds selected from alumina, zirconia, partially stabilized zirconia, and the stabilizer is used as the nanoparticles (the first nanoparticles and the second nanoparticles).

Further, it is preferable to use partially stabilized zirconia as the ion-conductive ceramics in the ion-conductive ceramics slurry preparation step, and use alumina as the first nanoparticles in the first nanoslurry preparation step.

Further, it is more preferable to use alumina as the insulative ceramics in the insulative ceramics slurry preparation step, and use nanoparticles made of one or more kinds selected from zirconia, partially stabilized zirconia, and the stabilizer as the second nanoslurry in the second nanoslurry preparation step.

In these cases, in the finally obtainable gas sensor element, the solid electrolyte body and the insulator include the same elements. Accordingly, in case the solid electrolyte body and the insulator are laminated to constitute the gas sensor element, for example, it is possible to put the solid electrolyte body and the insulator in a good junction state.

Further, in the ion-conductive composite material forming step, as in the second invention, an ion-conductive composite material compact is made by forming the ion-conductive composite material slurry.

Further, in the insulative composite material forming step, as in the fourth invention, an insulative composite material compact is made by forming the insulative composite material slurry.

Further, in the electrode print step, as in the second invention, a pair of electrode print sections are formed such that at least a part of the ion-conductive composite material compact is held therebetween.

Further, in the baking step, the ion-conductive composite material compact and the insulative composite material compact are baked integrally. In the baking step, baking can be performed by heating at a temperature of 1400-1550 degrees C.

In this way, the gas sensor element including a solid electrolyte body consisting primarily of ion-conductive ceramics, an insulator consisting primarily of insulative ceramics, and a pair of electrodes formed such that at least a part of the solid electrolyte body is held therebetween. In the gas sensor element obtained by the sixth invention, at least a part of the solid electrolyte body is made of ion-conductive composite material in which nanoparticles with a particle diameter equal to or smaller than 100 nm are dispersed in a principal component composed of the ion-conductive ceramics by 0.1-20 weight %, and at least a part of the insulator is made of insulative composite material in which nanoparticles with a particle diameter equal to or smaller than 100 nm are dispersed in a principal component composed of the insulative ceramics by 0.1-20 weight %.

Next, in the seventh invention, to manufacture the gas sensor element, there are performed the first nanoslurry preparation step, ion-conductive slurry preparation step, ion-conductive composite material preparation step, ion-conductive composite material forming step, baking step, electrode forming step, second nanoslurry preparation step, insulative slurry preparation step, and insulative ceramics body forming step.

In the seventh invention, the first nanoslurry preparation step, ion-conductive slurry preparation step, insulative slurry preparation step, and second nanoslurry preparation step are steps similar to each of the steps of the second invention. Further, the ion-conductive composite material preparation step is a step similar with the second invention, and the insulative composite material preparation step is a step similar with the fourth invention.

In the ion-conductive composite material forming step, as in the second invention, an ion-conductive composite material compact is made by forming the ion-conductive composite material slurry.

In the baking step, as in the third invention, the solid electrolyte body is made by baking the ion-conductive composite material compact. In the electrode forming step, as in the third invention, a pair of electrodes are formed such that at least a part of the solid electrolyte body is held therebetween.

Further, in the insulative ceramics body forming step, as in the fifth invention, an insulative ceramics body is formed integrally with the solid electrolyte body by baking the insulative composite material slurry onto the solid electrolyte body, or by plasma-spraying the insulative composite material slurry onto the solid electrolyte body.

As above, in the seventh invention, as in the sixth invention, there can be obtained a gas sensor element including a solid electrolyte body made of an ion-conductive composite material in which nanoparticles with a particle diameter equal to or smaller than 100 nm are dispersed in a principal component composed of the ion-conductive ceramics by 0.1-20 weight %, an insulator consisting primarily of insulative ceramics in which nanoparticles with a particle diameter equal to or smaller than 100 nm are dispersed in a principal component composed of insulative ceramics by 0.1-20 weight %, and a pair of electrodes formed such that at least a part of the solid electrolyte body is held therebetween.

In the second to seventh inventions, each slurry (nanoparticle slurry, ion-conductive ceramics slurry, insulative ceramics slurry, ion-conductive composite material slurry, insulative composite material slurry) is a solid-phase dispersion liquid in which particles are dispersed.

As the solvent causing the nanoparticles, the particles of ion-conductive ceramics, and the particles of insulative ceramics to disperse, there can be used alcohol such as ethanol, 2-butanol etc., and various kinds of organic solvents etc., such as polyvinyl butyrate (PVB) and a benzyl butyl phthalate (BBP). It is possible to use a mixed solvent in which two or more kinds selected from these alcohol and organic solvents are mixed.

Further, it is preferable to perform, by use of a high-pressure dispersion apparatus including a flow channel serving as a passage of each slurry, and a collision section disposed midway of the flow channel, a high-pressure dispersion process where each slurry is pressure-fed to the flow channel of the high-pressure dispersion apparatus, to cause each slurry to disperse colliding with the collision section under pressure of 10-400 MPa in each step that prepares above each slurry (claim 8, claim 15, claim 22).

In this case, it is possible to prevent the nanoparticles, the particles of ion-conductive ceramics, and the particles of insulative ceramics from flocculating to form secondary particles, and to disperse the particles to nearly primary particles in each slurry. Further, it is possible to disperse the particles more uniformly, and to stably keep the uniform dispersion state for a long period of time. As a result, the uniformity of the internal composition of the solid electrolyte body and the insulator can be further improved, and uniformity of the dispersion of the nanoparticles can be further improved. Therefore, a gas sensor element excellent in strength can be obtained. Further, in this case, dispersion of the nanoparticles, the particles of ion-conductive ceramics, and the particles of insulative ceramics can be performed efficiently and continuously.

If the pressure is lower than 10 MPa, the dispersion may be insufficient, or precipitation may occur in the slurry in a relatively short time. On the other hand, it is practically difficult to apply pressure exceeding 400 MPa, and this may cause high cost.

Further, it is preferable that the high-pressure dispersion apparatus includes a mixing dispersion section in which a movable orifice is provided so as to move up and down, to perform the high-pressure dispersion process by using, as the collision section, a front end portion of the movable orifice exposed to the inside of the mixing dispersion section.

In this case, it is possible to produce pressure change or shock wave in the vicinity of a place (the front end portion) where the slurry collides with the movable orifice. As a result, it becomes possible to apply the actions of high miniaturization, dispersion, emulsification and mixture to the slurry, so that the nanoparticles, the particles of ion-conductive ceramics, and the particles of insulative ceramics can be uniformly dispersed efficiently and surely into the solvent, and the slurry in a long-term stable dispersion state can be prepared.

Further, with the high-pressure dispersion apparatus, it is possible to vary the volume of the flow channel by the movable orifice, and the volume of the flow channel can be controlled in accordance with the particle diameter or concentration of the particles contained in the introduced slurry. By this, it is possible to control the uniform dispersion optimally and stably.

As the high-pressure dispersion apparatus, a high-pressure homogenizer may be used. The high-pressure homogenizer pressure-feeds the slurry at high pressure to generate high-speed flow. And the shock wave can be produced by this high-speed flow. By this shock wave, it is possible to break flocculated portions of the nanoparticles, the particles of ion-conductive ceramics, and the particles of insulative ceramics, and disperse them to a primary particle state, to thereby obtain uniform slurry. Further, by pressure-feeding the slurry at a high pressure of 10-400 MPa as described above, it is possible to apply mechanical shear force to the slurry to cause it to disperse more uniformly.

Further, it is preferable to perform, in each step preparing each slurry, an agitating dispersion process in which each slurry is dispersed while being applied with shear force by being agitated (claim 10, claim 17, claim 24).

In this case, it is possible to prevent the nanoparticles, the particles of ion-conductive ceramics, the particles of insulative ceramics from flocculating to form secondary particles, and to disperse the particles to nearly primary particles in each slurry. Further, it is possible to disperse the particles more uniformly, and to stably keep the uniform dispersion state for a long period of time. As a result, the uniformity of the internal composition of the solid electrolyte body and the insulator can be further improved, and uniformity of the dispersion of the nanoparticles can be further improved. Therefore, a gas sensor element excellent in strength can be obtained. Further, in this case, dispersion of the nanoparticles, the particles of ion-conductive ceramics, and the particles of insulative ceramics can be performed efficiently and continuously.

It is preferable that the agitating dispersion process is performed by agitating each slurry in an agitation tank including a closed pressure-tight container, and rotary vanes mounted on a rotating shaft provided in the closed pressure-tight container (claim 11, claim 18, claim 25).

In this case, the slurry can be applied with shear force with facility.

That is, when each slurry is pressure-fed to the agitation tank, the slurry is pressed against the inner wall surface of the closed pressure-tight container by the centrifugal force caused by the rotation of the rotary vanes in the closed pressure-tight container. The slurry can be given mechanical shear force due to shear stress caused accordingly.

Further, it is preferable that the agitating dispersion process is performed under pressure of 10-400 MPa.

If the pressure is below 10 MPa, the dispersion into the solvent becomes insufficient, and precipitation of nanoparticles may occur in the slurry in a relatively short time. On the other hand, if the pressure is as high as beyond 400 MP. It is difficult to apply to the slurry, and since an apparatus having extremely high-pressure tightness needs to be used, manufacturing cost may increase.

Further, it is preferable that a clearance between the rotary vanes and the closed pressure-tight container is not larger than 5 mm.

In this case, the slurry present in the front ends (the ends on the side closer to the inner wall surface of the closed pressure-tight container) of the rotary vanes are all agitated by the rotary vanes. As a result, it becomes possible to apply the actions of high miniaturization, dispersion, mixture, emulsification, etc. to the slurry.

Further, the slurry present in the inner side and the outer side of the rotation plane of the rotary vanes are mixed by velocity difference due to the inertial of the slurry itself, generation of eddy flows, etc.

Further, in the second and the third inventions, it is preferable to disperse the slurry of one or more kinds selected from the nanoparticle slurry, ion-conductive ceramics slurry, ion-conductive composite material slurry, and insulative ceramics slurry by applying ultrasonic sound thereto (claim 12).

Further, in the fourth and fifth inventions as well, it is preferable to disperse the slurry of one or more kinds selected from the ion-conductive ceramics slurry, nanoparticle slurry, insulative ceramics slurry, and insulative composite material slurry by applying ultrasonic sound thereto (claim 19).

Further, in the sixth and seventh inventions as well, it is preferable to disperse the slurry of one or more kinds selected from the ion-conductive ceramics slurry, first nanoparticle slurry, ion-conductive composite material slurry, insulative ceramics slurry, second nanoparticle slurry, and insulative composite material slurry by applying ultrasonic sound thereto (claim 26).

As described above, by applying ultrasonic sound to each slurry, it is possible to prevent the particles contained in each slurry from re-flocculating. Accordingly, it is possible to keep the uniform dispersion stable for a long period of time.

The above dispersion by ultrasonic sound may be performed in the steps dispersing each slurry (nanoslurry preparation step, ion-conductive slurry preparation step, insulative slurry preparation step, ion-conductive composite material slurry preparation step, and insulative composite material preparation step). At this time, the dispersion by ultrasonic sound may be performed in conjunction with the high-pressure dispersion process, and the agitating dispersion process.

Further, the dispersion by ultrasonic sound may be performed immediately before the steps forming each slurry (ion-conductive ceramics preparation step, insulative ceramics preparation step, ion-conductive composite material preparation step, insulative material composite material preparation step), and the step baking or plasma-spraying the insulative ceramics slurry or the insulative composite material slurry (the insulative ceramics body forming step).

### EMBODIMENTS

### Embodiment 1

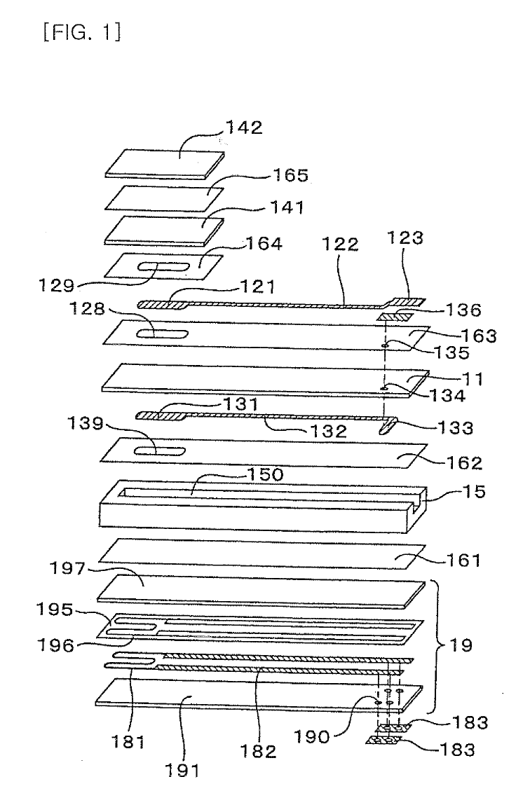

Next, a gas sensor element according to an embodiment of the invention is explained with reference to FIG. 1 to FIG. 3.

The gas sensor element 1 of this embodiment includes a solid electrolyte body 11, insulators 15, 141, 142, 191, 195, 197, 163, 161, 162, 164, 165, a pair of electrodes 121, 131 formed such that the solid electrolyte body 11 is held therebetween, and a heater 19. The solid electrolyte body 11 is made of partially stabilized zirconia. Further, the insulators 15, 141, 142, 191, 195, 197, 163, 161, 162, 164, 165 are made of insulative composite material in which the nanoparticles 10 with a particle diameter equal to or smaller than 100 nm are dispersed by 2 weight % in a principal component composed of insulative ceramics having electrical insulativity.

In this embodiment, the pair of the electrodes 121, 131 are a measured gas side electrode 121 facing a measured gas atmosphere, and a reference electrode 131 facing a reference gas atmosphere, respectively. The solid electrolyte body 11 is laminated with the gas-permeable insulator (diffusion layer) 141 covering the measured gas side electrode 121, and the diffusion layer 141 is laminated with the gas-impermeable insulator (shield layer) 142.

In the following, explanation is made in detail.

The gas sensor element 1 of this embodiment is used incorporated in a gas sensor mounted on an exhaust system of a vehicle engine. This gas sensor measures oxygen concentration in an exhaust gas, and detects air-fuel ratio of the engine from a measured value, the air-fuel ratio being used for combustion control of the engine.

As shown in FIG. 1-FIG. 3, the gas sensor element 1 of this embodiment is structured by laminating the reference gas chamber forming plate (insulator) 15, solid electrolyte body 11, diffusion layer 141, and shield layer 142.

The reference gas chamber forming plate 15 includes a groove section 150 having a U-shaped cross section, which serves as a reference gas chamber into which a reference gas is introduced.

The solid electrolyte body 11, which includes the measured gas side electrode 121, and reference electrode 131, is provided with lead sections 122, 132 which electrically connect to these electrodes 121, 131.

Further, the diffusion layer 141 is laminated so as to cover the measured gas side electrode 121, and the shield layer 142 is laminated so as to cover the diffusion layer 141.

Further, the gas sensor element 1 of this embodiment is integrally provided with the ceramic heater 19 at a surface of the reference gas chamber forming plate 15 opposite to the solid electrolyte body 11.

The ceramic heater 19 is constituted by a heater sheet 191, a heat generating element 181 provided in the heater sheet 191, a lead section 192 supplying power to the heat generating element 181, and two heater insulating plates 195, 197 laminated so as to cover the heat generating element 181.

The heater insulating plate 195 has a window section 196. This window section 196, which has the same shape as the heat generating element 181 and the lead section 182 to be able to incorporate both of them, is provided to smooth unevenness when the heat generating element 181 and the lead section 182 are put between the heater sheet 191 and the heater insulating plate 197.

Further, the lead section 182 electrically connects to a terminal 183 through a through hole 190 provided in the heater sheet 191.

Between the heater insulating plate 197 and the reference gas chamber forming plate 15, between the reference gas chamber forming plate 15 and the solid electrolyte body 11, and between the diffusion layer 141 and the shield layer 142, there are intercalated adhesion layers 161, 162, 165, respectively. Further, the insulating layer 163 and the adhesion layer 164 are intercalated between the solid electrolyte body 11 and the diffusion layer 14.

The reference gas chamber forming plate 15, diffusion layer 141, heater sheet 191, heater insulating plates 195, 197, insulating layer 163, and the adhesion layers 161, 162, 164, 165 are all insulators, and these insulators consist primarily of alumina as insulative ceramics.

Further, the porosity of the diffusion layer 141 is 14%.

In each of the insulators 15, 141, 142, 191, 195, 197, 161, 162, 163, 164, 165, the nanoparticles 10 with a particle diameter equal to or smaller than 100 nm are dispersed in a principal component composed of each insulative ceramics (alumina) by about 2 weight %. Incidentally, in this embodiment, commercially available zirconia nanoparticles (particle diameter being about 10-50 nm) were used as the nanoparticles 10.

Further, the solid electrolyte body 11 is made of partially stabilized zirconia in which yttria is added to zirconia by 6 mol %.

The solid electrolyte body 11 includes the reference electrode 131 facing the groove section 150 serving as the reference gas chamber, and the adhesion layer 162 includes a window 139 at a position facing the reference electrode 131. Further, the reference electrode 131 electrically connects to a terminal 136 through the lead section 132, an internal terminal 133, a conductive through hole provided 134 in the solid electrolyte body 11, and a conductive through hole 135 provided in the insulating layer 163.

The insulating layer 163, and the adhesion layer 164 include windows 128, 129 at positions facing the measured gas side electrode 121. Further, the measured gas side electrode 121 electrically connects to a terminal 123 through the lead section 122.

The output of the gas sensor element 1 can be obtained through the terminals 123, 136.

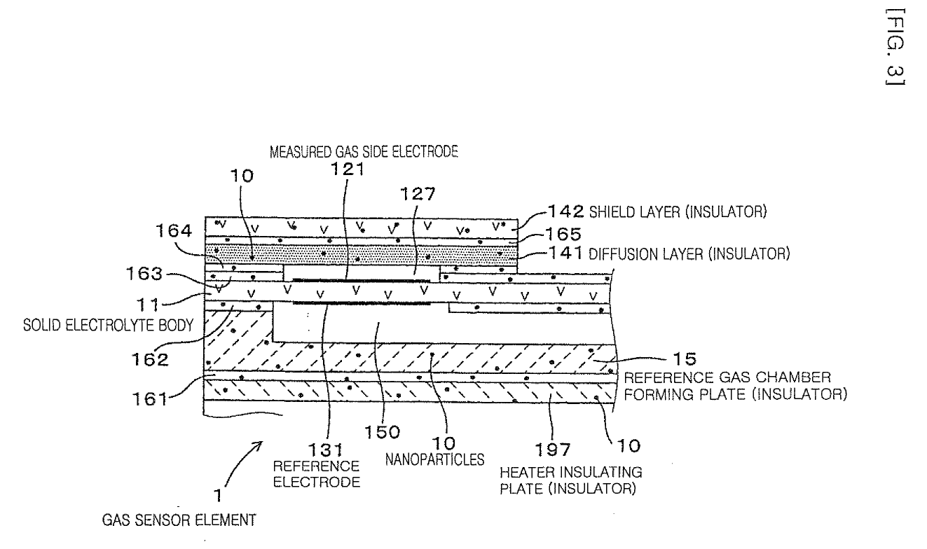

Further, as shown in FIG. 3, the windows 128, 129 provided in the insulating layer 163 and the adhesion layer 164 serve as a small chamber 127 housing the measured gas side electrode 121 by lamination. A measured gas is introduced into this small chamber 127 through the diffusion layer 141.

Next, explanation is made as to a method of manufacturing the gas sensor element 1 of this embodiment.

In the manufacturing method of this embodiment, a gas sensor element is manufactured by performing the nanoslurry preparation step, ion-conductive slurry preparation step, insulative slurry preparation step, insulative composite material preparation step, ion-conductive ceramics forming step, insulative composite material forming step, electrode print section forming step, and baking step.

To be more precise, a green sheet for the solid electrolyte body 11 is fabricated by the doctor blade method, or extrusion molding method. Subsequently, print sections for forming the measured gas side electrode 121, reference electrode 131, lead section 132, and internal terminal 133 are provided in this green sheet.

Incidentally, the green sheet for the solid electrolyte body 11 is provided with the through hole 134 in advance.

An unbaked compact for the reference gas chamber forming plate 15 is made by injection molding, cutting fabrication, press molding, laminating fabrication of green sheets, etc. Further, green sheets for the heater sheet 191, shield layer 142, and diffusion layer 141 are fabricated by the doctor blade method, extrusion molding method, etc.

Further, the shield layer 142, and the diffusion layer 141 may be made of slurry.

Further, the green sheet for the heater sheet 191 is provided with a print section for the heat generating element 181 etc.

Further, for the various adhesion layers 161, 162, 164, 165, and the insulating layer 163, a slurry for the adhesion layer or insulating layer is made, and printed to the green sheets. Those having the windows 129, 139, 128, are formed by screen printing using slurry, and the heater insulating plates 195, 197 are formed by screen printing using slurry as well.

Further, the green sheet for the solid electrolyte body 11 is provided with print sections for forming the measured gas side electrode 121, lead section 122, and terminals 136 and 123, after being applied with slurry for the insulating layer 163.

Further, in case at least one of the shield layer 142 and the diffusion layer 141 is made by slurry, the adhesion layer 165 may be eliminated. Further, in case the diffusion layer 141 is made by slurry, it may be overlaid on the adhesion layer 164. That is, it is possible to form the adhesion layer 164 integrally with the diffusion layer 141.

Incidentally, the green sheets or slurry for forming the reference gas chamber forming plate 15, diffusion layer 141, shield layer 142, heater sheet 191, heater insulating plates 195, 197, insulating layer 163, and adhesion layers 161, 162, 164, 165 were made by adding solvent such as alcohol such as ethanol, 2-butanol etc., acetic acid isoamyl alcohol, sorbitan trioleate (SPN), polyvinyl butyrate (PVB), benzyl butyl phthalate (BBP) into insulative composite material in which the nanoparticles (zirconia nanoparticles) 10 are dispersed in a principal component composed of insulative ceramics (alumina) by 2 weight %. The green sheets were made by forming slurry (insulative 1 composite material slurry) in which the insulative ceramics and nanoparticles 10 are dispersed in a solvent. The insulative composite material slurry was prepared by mixing insulative ceramics slurry made by dispersing insulative ceramics in a solvent, and nanoparticle slurry prepared by dispersing nanoparticles in a solvent.

Further, the green sheet for the solid electrolyte body was made by preparing slurry (ion-conductive ceramics slurry) by dispersing, into solvent, ion-conductive ceramics made of partially stabilized zirconia in which yttria is added to zirconia by 6 mol %, and by forming this slurry.

Further, preparation of each slurry was performed by the high-pressure dispersion process by use of the high-pressure dispersion apparatus (high-pressure homogenizer).

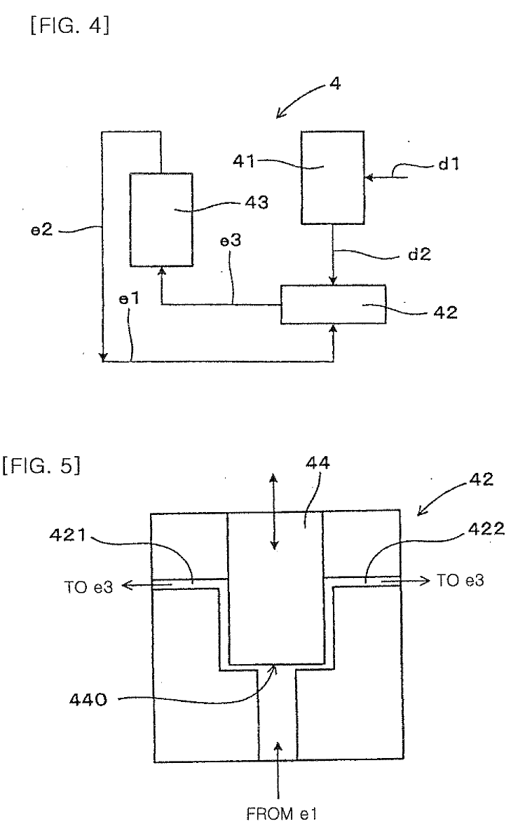

As shown in FIG. 4 and FIG. 5, the high-pressure dispersion apparatus 4 includes the mixing dispersion section 42 in which the movable orifice 44 is provided so as to move up and down. The mixing dispersion section 42 is connected to a storage tank 43 by pipings e1, e2, e3. Further, the high-pressure dispersion apparatus 4 is provided with a high-pressure pump 41 for driving the movable orifice 44. The high-pressure pump 41 and the movable orifice 44 are driven by compressed air shown by the arrows d1, d2.

In the high-pressure dispersion process, each slurry is introduced from the piping e1 of the high-pressure dispersion apparatus 4. The introduced slurry is pressure-fed to the mixing dispersion section 42, and collides with a front end (collision section 440) of the movable orifice 44 under high pressure (200 MPa). At this time, the slurry forms a high-speed flow, and flocculated portions in the slurry are broken by shock formed by this high-speed flow, enabling them to disperse to a primary particle state. Further, at the time of high-pressure feeding, mechanical shear force is applied to the slurry, and more uniform dispersion can be promoted by this shear force.

After collision with the collision section 440, the slurry diverges, flows out from two exists 421, 422, converges at the piping e3, and returns to the storage tank 43. It is possible to cause the slurry to circulate again from the storage tank 43 to the mixing dispersion section 42 through the pipings e2 and e1.

Each of the green sheets made as above were laminated in the order shown in FIG. 1, and pressed, as a consequence, they adhered mutually by the adhesiveness (glutinosity) of the adhesion layers 161, 162, 164, 165, and an unbaked laminated body was obtained. This unbaked laminated body was baked by being heated up to 1470° C.

Thereafter, by cooling down from 1470 degrees C. to room temperature, the gas sensor element 1 of this embodiment was obtained.

Functions and effects of this embodiment are explained.

In the gas sensor element 1 of this embodiment, the reference gas chamber forming plate 15, diffusion layer 141, shield layer 142, heater sheet 191, heater insulating plates 195, 197, insulating layer 163, and adhesion layers 161, 162, 164, 165 are insulators made of insulative composite material. That is, the insulators consist primarily of alumina in which the nanoparticles 10 with a particle diameter equal to or smaller than 100 nm are dispersed.

Accordingly, the insulators 15, 141, 142, 191, 195, 197, 161, 162, 163, 164, 165 can withstand large stress exceeding 350 MPa, for example, and can exhibit excellent strength. Therefore, even if the gas sensor element is flooded, and large stresses occur in the insulators, it is possible to prevent the insulators 15, 141, 142, 191, 195, 197, 161, 162, 163, 164, 165 from being broken.

Accordingly, it is possible to suppress that accuracy of measurement of concentrations of various kinds of gas by the gas sensor element 1 is lost.

In particular, in the gas sensor element 1 of this embodiment, the insulative composite material makes the insulating layer 163, adhesion layers 164, 165, diffusion layer 141 and shield layer 142 which directly contacts during operation, a gas such as the exhaust gas, the reference gas chamber forming plate 15 and the adhesion layer 162 which contact the reference gas, and the heater sheet 191 and the heater insulating plates 195, 197 of the heater 19 which easily undergo temperature change and contact the external atmospheric air. Accordingly, even if portions where various gases such as the exhaust gas, atmospheric air and reference gas are in contact with the various insulators 15, 141, 142, 191, 195, 197, 161, 162, 163, 164, 165 are flooded, and large stresses occur, since the various insulators exhibit excellent strength as described above, it is possible to prevent occurrence of fracture or breakage.

Further, in the various insulators 15, 141, 142, 191, 195, 197, 161, 162, 163, 164, 165, the nanoparticles 10 are dispersed in the principal component composed of alumina by 2 weight %. Therefore, the insulativity of the insulators 15, 141, 142, 191, 195, 197, 161, 162, 163, 164, 165 are sufficiently assured.

Accordingly, the gas sensor element 1 can exhibit excellent strength while assuring the function as a gas sensor element.

Therefore, if the gas sensor element 1 is applied with large stress, occurrence of breakage such as fracture etc. can be prevented. Thence, the gas sensor element 1 can perform correct detection, and is excellent in reliability.

### Embodiment 2

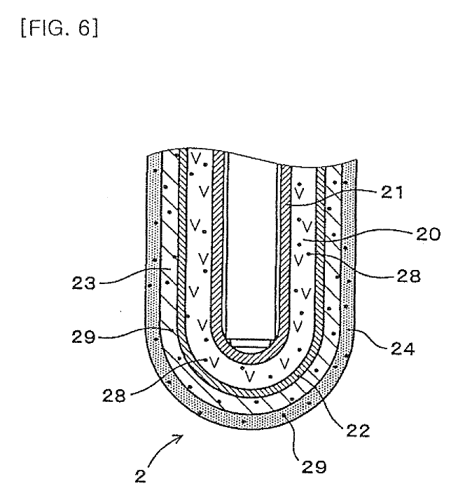

As shown in FIG. 6, this embodiment is an example of a oxygen concentration electromotive force type gas sensor element 2 having a bottomed cylinder shape, and a cup-shape.

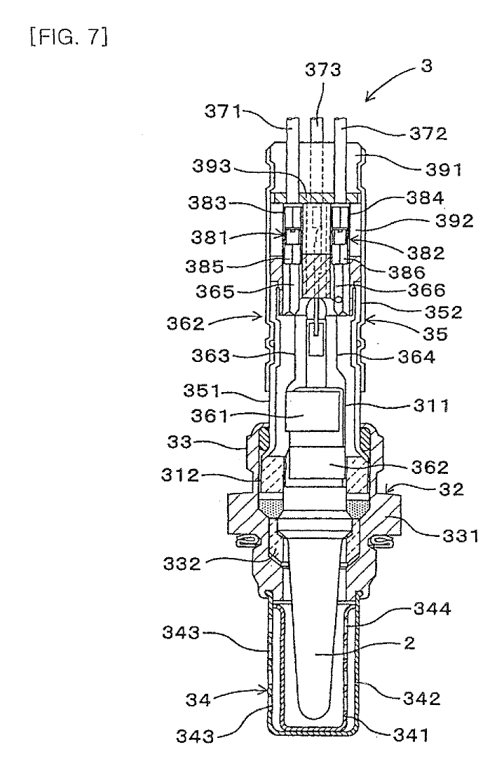

As shown in FIG. 7, this element is incorporated in an oxygen sensor. And this oxygen sensor is mounted on an exhaust pipe of a vehicle engine to detect an air-fuel ratio from oxygen concentration in the exhaust gas, which is in a close relationship with the air-fuel ratio of a mixture gas supplied for combustion.

As shown in FIG. 6 and FIG. 7, the gas sensor element 2 is constituted by a solid electrolyte body 20, a pair of a measured gas side electrode 22 and a reference gas side electrode 21, these constituting an electrochemical cell. The oxygen concentration in the exhaust gas is measured by this cell.

There are further included a porous protection layer 23 protecting the measured gas side electrode 22 and controlling diffusion of the measured gas, and a porous protection layer 24 covering the porous protection layer 23. The porous protection layers 23, 24 are insulators formed by spray of MgO.Al2O3 spinel.

In this embodiment, the solid electrolyte body 20 consists primarily of partially stabilized zirconia that is ion-conductive ceramics, in which nanoparticles 28 made of alumina are dispersed.

Further, the porous protection layers (insulator) 23, 24 consist primarily of alumina, to be more precise, Al2O3.Mgo, in which nanoparticles 29 made of partially stabilized zirconia are dispersed.

FIG. 7 is an oxygen sensor 3 incorporating the gas sensor element 2 of this embodiment.

The oxygen sensor 3 includes the gas sensor element 2 forming an electrochemical cell, and a housing 32 housing the gas sensor element 2.

The housing 32 includes a body section 33 provided with a flange 331 at its roughly center portion, an exhaust cover 34 located below the body section 33 and inserted into the exhaust pipe of the vehicle engine, and an atmospheric cover 35 located above the body section 33 and contacting the atmospheric air. The exhaust cover 34 includes an inner cover 341 and an outer cover 342 respectively made of stainless steel, the inner cover 341 and the outer cover 342 being provided with exhaust gas introducing ports 343, 344.

On the other hand, the atmospheric cover 35 includes a main cover 351 fitted to the body section 33, and a sub-cover 352 covering a rear end of the main cover 351, the main cover 351 and the sub-cover 352 being provided with not-shown atmospheric air introducing ports.

And the gas sensor element 2 is held to the inside of the housing 32 of the oxygen sensor 3 through an insulating member 332.

Further, a terminal section led from the reference gas side electrode 21 of the gas sensor element 2, and a terminal section led from the measured gas side electrode 22 (both are omitted from illustration) are provided with plate-like metal terminals 361, 362 holding them so as to envelope them.

And the plate-like terminals 361, 362 are connected to output-extracting leads 371, 272.

That is, in the plate-like terminals 361, 362, strip-like terminal pieces 363, 364 are provided in contact pieces 365, 366 so as to protrude therefrom. And the terminal pieces 363, 364 are connected to one ends 385, 386 of connectors 381, 382 whose other ends 383, 384 are connected to the leads 371, 372.

In the plate-like terminals 361, 362, a metal plate of an inverse T-shape is deformed cylindrically to hold therein the terminal section led from the reference gas side electrode 21, and the terminal section led from the measured gas side electrode 22.

And, an appropriate contact pressure is applied between the plate-like terminals 361, 362, and the reference gas side and measured gas side electrodes by spring elastic force of the metal plate.

On the other hand, since tensile force to the axial direction of the oxygen sensor 2 acts on the leads 371, 372, it may occur that the plate-like terminals 361, 362 are pulled through the connectors 381, 382, and slide in the axial direction.

To prevent this, the oxygen sensor 3 is provided with a stopper 393 held between rubber bushes 391, 392 at its end portion. The stopper 393 is for suppressing movement of the connectors 381, 382, and is formed by resin material to keep insulation between the leads 371, 372,

Incidentally, the numeral 373 denotes a current-carrying wire for the heater heating the gas sensor element 2.

And the oxygen sensor 3 is inserted into the exhaust pipe of the vehicle engine at the exhaust cover 34, and fixed to the exhaust pipe of the vehicle engine at the flange 331.

As shown in FIG. 6, the oxygen sensor 3 having the above structure incorporates the gas sensor element 2 that includes the reference gas side electrode 21 and the measured gas side electrode 22 provided in the both sides of the solid electrolyte body 20 which is an oxygen ion conductor to form an electrochemical cell, the measured gas side electrode 22 being exposed to the exhaust gas, and the reference gas side electrode 21 being exposed to the atmospheric air to detect an air-fuel ratio from a potential difference between the electrodes caused by an oxygen concentration difference of the atmospheres to which they are exposed.

Next, explanation is made as to a manufacturing method of the gas sensor element 2 of this embodiment.

In this embodiment, the gas sensor element is manufactured by performing the ion-conductive slurry preparation step, first nanoslurry preparation step, insulative slurry preparation step, second nanoslurry preparation step, ion-conductive composite material preparation step, insulative composite material preparation step, ion-conductive composite material forming step, baking step, electrode forming step, and insulative ceramics body forming step.

First, 98 weight parts of partially stabilized zirconia and an appropriate quantity of resolvent were mixed to obtain the ion-conductive ceramics slurry. Further, 2 weight parts of nanoparticles 28 (particle diameter 10-50 nm) made of alumina and an appropriate quantity of resolvent were mixed to obtain the first nanoparticle slurry.

Subsequently, the ion-conductive ceramics slurry and the first nanoparticle slurry were mixed to prepare the ion-conductive composite material slurry. In this ion-conductive composite material slurry, the ion-conductive ceramics and the first nanoparticles are dispersed in the solvent. This ion-conductive composite material slurry were formed in a cup shape, and baked to make the solid electrolyte body 20. Next, platinum was deposited to the inner surface and outer surface of the solid electrolyte body 20 by electroless plating, and this was heat-treated to form the reference gas side electrode 21 and measured gas side electrode 22.

Subsequently, the porous protection layer 23 was formed so as to cover the surface of the measured gas side electrode 22 etc., by plasma-spraying. The porous protection layer 23 was formed by use of insulative composite material slurry in which the nanoparticles 29 are dispersed in a principal component composed of Al2O3.MgO spinel by 2 weight %. The insulative composite material slurry was prepared by mixing insulative ceramics slurry in which 99 weight parts of insulative ceramics (Al2O3.MgO spinel) are dispersed in an appropriate quantity of solvent, and the second nanoparticle slurry in which 1 weight part of nanoparticles are dispersed in appropriate quantity of solvent. Further, as in embodiment 1, commercially available zirconia nanoparticles (particle diameter being about 10-50 nm) were used as the nanoparticles 29.

Further, the insulative composite material slurry was adhered so as to cover the porous protection layer 23 by dipping or spraying, and after being dried, baked in a non-oxidizing atmosphere at 500° C.-900° C. to form the porous protection layer 24.

Through such processes, the gas sensor element 2 of this embodiment was obtained.

Further, in this embodiment, preparation of each slurry was performed by the agitating dispersion process using a high-speed shearing mixer having an agitation tank including a closed pressure-tight container and agitating vanes.

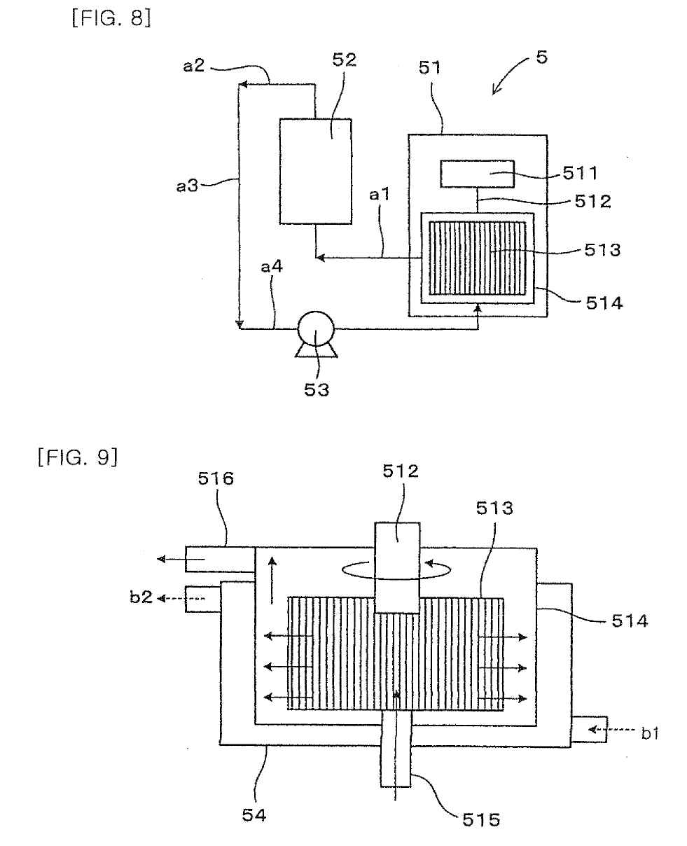

As shown in FIG. 8 and FIG. 9, the high-speed shearing mixer 5 includes an agitation tank 51 including a closed pressure-tight container 514 and rotary vanes 513 rotatably fixed to its inner rotating shaft 512.

As shown in FIG. 9, the closed pressure-tight container 514 is formed with a flow channel inlet 515, and a flow channel outlet 516 serving as a doorway to this closed pressure-tight container 514.

Further, as shown in FIG. 8 and FIG. 9, the rotating shaft 512 is disposed concentrically with the closed pressure-tight container 514, and one end of the rotating shaft 512 is coupled to a high-speed motor 511 outside the closed pressure-tight container. Further, the rotary vanes 513 is made slightly smaller in diameter than the inner diameter of the closed pressure-tight container 514. In FIG. 8 and FIG. 9, the clearance between the rotary vanes 512 and the closed pressure-tight container is indicated relatively large to facilitate understanding, however, actually, this clearance is about 2 mm.

Further, as shown in FIG. 8, the high-speed shearing mixer 5 further includes a storage tank 52, and pump apparatus 53. The agitation tank 51, storage tank 52, and pump apparatus 53 are coupled to one another by pipings a1-a4.

Further, as shown in FIG. 9, the high-speed shearing mixer 5 includes a cooling section 54 at the outer surface of the closed pressure-tight container 514. By passing cooling waters b1, b2 through this cooling section 54, it is possible to suppress the inside of the closed pressure-tight container 514 from becoming high temperature.

When the slurry is pressure-fed to the high-speed shearing mixer 5, this slurry circulates among the closed pressure-tight container 514, storage tank 52, and the pump apparatus 53 coupled by the flow channels a1-a4. The slurry rotates by receiving the energy of the rotary vanes 513, and is pressed against the inner surface of the closed pressure-tight container 514 by centrifugal force. By this, the pressure increases, and the slurry rotates in a form of a thin film hollow cylinder. The rotation of the slurry occurs not only at portions contacting the rotary vanes 513, but also at portions distant from the rotary vanes 513 inspired by the movement of the slurry rotated by the rotary vanes 513. Further, when air is present in the closed pressure-tight container 514, the rotation is transmitted to the slurry through rotation of the air. The rotation speed of the rotary vanes 513 is faster than the rotation speed of the slurry, and the slurry present in the vicinity of an end section of the rotary vanes 513 is all agitated by the rotary vanes, because the clearance between the closed pressure-tight container 514 and the rotary vanes is small. Because of being highly miniaturized by this, there occur actions of dispersion, mixture, emulsification, etc.

Further, the slurry present in the inner side or the outer side of the rotation plane of the rotary vanes 513 undergoes the actions of dispersion, mixture, emulsification, etc. also by velocity difference due to the inertia of the slurry itself, generation of eddy flows, etc.

In this way, the slurry is dispersed and mixed while circulating among the closed pressure-tight container 514, storage tank 52, and pump apparatus 53, and as a result, the uniformly dispersed and mixed slurry can be obtained. Incidentally, other than the above, the slurry is uniformly dispersed by the similar actions with embodiment 1.

In the high-speed shearing mixer 5 of this embodiment, each slurry is pressure-fed under high pressure to form a high-speed flow, and shock wave is produced by this high-speed flow. By this shock wave, flocculated portions of the nanoparticles, particles of ion-conductive ceramics, and particles of insulative ceramics in the slurry are broken, and dispersed to a primary particle state to thereby obtain uniform slurry.

Each slurry in this embodiment was prepared as described above.

As shown in FIG. 6, in the gas sensor element 2 of this embodiment, the porous protection layers 23, 24 are made of the insulative composite material as in the case of embodiment 1. That is, in the porous protection layers 23, 24, the nanoparticles 29 are dispersed in the principal component composed of insulative ceramics (Al2O3.MgO).

Further, in the gas sensor element 2, the solid electrolyte body 20 is made of the ion-conductive composite material. That is, in the solid electrolyte body 20, the nanoparticles 28 are dispersed in a principal component composed of ion-conductive ceramics (partially stabilized zirconia).

Accordingly, the porous protection layers 23, 24, and the solid electrolyte body 20 can exhibit excellent strength.

Further, in the gas sensor element 2, the porous protection layers 23, 24 easily contact the exhaust gas. Accordingly, the porous protection layers 23, 24 are easily flooded by the moisture contained in the exhaust gas. As a result, there may occur a large stress in the porous protection layers 23, 24.

Further, the solid electrolyte body 20 easily contacts the exhaust gas that has passed through the porous protection layers 23, 24. Accordingly, the solid electrolyte body 20 is easily flooded by the moisture contained in the exhaust gas when there occurs a rapid temperature change of the gas sensor element 2. As a result, there may occur a large stress in the solid electrolyte body 20.

In this embodiment, as described above, since the porous protection layers 23, 24 are made of the insulative composite material and the solid electrolyte body 20 is made of the ion-conductive composite material, it is possible to show excellent strength. Accordingly, as described above, if applied with a stress due to flooding, the solid electrolyte body 20 and the porous protection layers 23, 24 show excellent resistance to the stress, making it possible to prevent fracture etc. from occurring

### EXPERIMENT EXAMPLE

This example is an example in which an insulator is fabricated from insulative composite material similar with embodiment 1 and embodiment 2, and its strength is reviewed.

The insulator of this example is made of insulative composite material in which nanoparticles are dispersed in a principal component composed of alumna. In this example, a plurality of insulators having different mixture ratios of nanoparticles are fabricated, and strengths of these insulators are compared and evaluated.

First, the insulators are fabricated.

To be more precise, commercially available zirconia nanoparticles (particle diameter being about 10-50 nm) were prepared first. Subsequently, the nanoparticles and alumina were weighed to be 100 g in total in the ratios shown in Table 1, and ion-exchange water was weighed to be 150 g, and put in a 2-Liter pot, followed by being mixed for three hours by a ball mill. Thereafter, the mixture was dried in an evaporating dish at 150 degrees C. for about 20 hours.

After being dried, and then crushed in a mortar, 10% PVA (polyvinyl alcohol) solution was sprayed by 5 weight % to powder weight, to perform spray granulation. Next, the spray granulated particles were passed through a sieve with #50-#100 mesh, and press-formed in a plate-like shape having a thickness of 3.5-3.8 mm by a metal mold. The forming pressure at the forming was set at 60 MPa.

Subsequently, a plate-like compact was baked, and both end portions of the sintered compact were cut. After that, an insulator with a thickness of 3 mm, a width of 4 mm, and a length of 50 mm was made.

In this example, 12 kinds of insulators (samples E1-E9, and samples C2-C4) were fabricated by changing mixture ratios of alumina and the nanoparticles, in the same way as above as for others.

Sample E1 was fabricated as above by setting the blending quantity of alumina at 99.9 g, and setting the blending quantity of the nanoparticles at 0.1 g.

Sample E2 was fabricated in the same way as in sample E1, except that the blending quantity of alumina was set at 99.8 g, and the blending quantity of the nanoparticles was set at 0.2 g.

Sample E3 was fabricated in the same way as in sample E1, except that the blending quantity of alumina was set at 99.5 g, and the blending quantity of the nanoparticles was set at 0.5 g.

Sample E4 was fabricated in the same way as in sample E1, except that the blending quantity of alumina was set at 99 g, and the blending quantity of the nanoparticles was set at 1 g.

Sample E5 was fabricated in the same way as in sample E1, except that the blending quantity of alumina was set at 98 g, and the blending quantity of the nanoparticles was set at 2 g.

Sample E6 was fabricated in the same way as in sample E1, except that the blending quantity of alumina was set at 95 g, and the blending quantity of the nanoparticles was set at 5 g.

Sample E7 was fabricated in the same way as in sample E1, except that the blending quantity of alumina was set at 90 g, and the blending quantity of the nanoparticles was set at 10 g.

Sample E8 was fabricated in the same way as in sample E1, except that the blending quantity of alumina was set at 85 g, and the blending quantity of the nanoparticles was set at 15 g.

Sample E9 was fabricated in the same way as in sample E1, except that the blending quantity of alumina was set at 80 g, and the blending quantity of the nanoparticles was set at 20 g

Sample C2 as an comparative sample was fabricated in the same way as in sample E1, except that the blending quantity of alumina was set at 99.95 g, and the blending quantity of the nanoparticles was set at 0.05 g.

Sample C3 as an comparative sample was fabricated in the same way as in sample E1, except that the blending quantity of alumina was set at 70 g, and the blending quantity of the nanoparticles was set at 30 g.

Sample C4 as an comparative sample was fabricated in the same way as in sample E1, except that the blending quantity of alumina was set at 50 g, and the blending quantity of the nanoparticles was set at 50 g.

Further, in this example, an insulator made of alumina not containing the nanoparticles was fabricated for comparison use. This is referred to as sample C1.

Sample C1 was fabricated in the same way as in sample E1, except that the blending quantity of alumina was set at 100 g, and the blending quantity of the nanoparticles was set at 0 g.

Next, transverse rupture strength and thermal expansion coefficient were measured for each of sample E1-sample ED, and samples C1-C4.

[Transverse Rupture Strength]

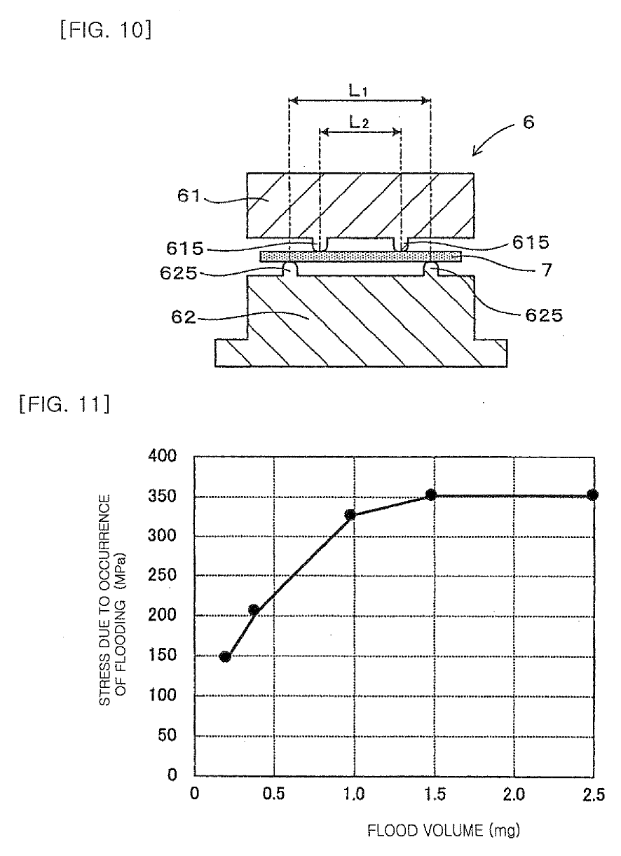

As shown in FIG. 10, transverse rupture strength was measured by a pressing machine with a load cell.

First, as shown in this figure, the insulator 7 of each sample (sample E1-sample E9, and samples C1-C4) was held between an upper pressurizer 61 and a lower pressurizer 62 of the pressing machine. Subsequently, a load was applied to the insulator 7 by narrowing the interval between the upper pressurizer 61 and the lower pressurizer 62, and the load P when the insulator 7 was broken was measured.

Incidentally, the lower pressurizer 62 is provided with two projections 625 spaced to each other by an interval of L1 mm, and the upper pressurizer 61 is provided with two projections 615 spaced to each other by an interval of L2 mm. The insulator 7 is placed such that the center of the longitudinal direction (length direction) comes to the center of the distance between the projections 625 of the lower pressurizer 62, and to the center of the distance between the projections 615 of the upper pressurizer 61.

The transverse rupture strength S can be calculated from the load P when broken, the distance L1 between the projections of the lower pressurizer, the distance L2 between the projections of the upper pressurizer, the width of the sample, and the thickness t of the sample in accordance with the following expression (1).

The results are shown in Table 1.

S=3P(L1−L2)/2Wt2 (1)

Incidentally, L1=24 (mm) r L2=10 (mm), W=4 mm, and t=3 mm.

[Thermal Expansion Coefficient]

Thermal expansion coefficient was measured in a temperature range from room temperature to 900° C. by use of THERMOMECHANICAL ANALYZER (TMA-50) of Shimadzu Corp. make.

The results are shown in Table 1.

TABLE 1

| | | Nano- | Transverse | Thermal |
|---|---|---|---|---|
| | Sample | particles | rapture | expansion |
| | No. | (weight %) | strength (Mpa) | coefficient (1/K) |
| Comparative | C1 | 0 | 400 | 7.40 × 10⁻⁶ |
| example | | | | |
| Comparative | C2 | 0.05 | 410 | 7.4 × 10⁻⁶ |
| example | | | | |
| Embodiment | E1 | 0.1 | 550 | 7.42 × 10⁻⁶ |
| Embodiment | E2 | 0.2 | 600 | 7.45 × 10⁻⁶ |
| Embodiment | E3 | 0.5 | 650 | 7.55 × 10⁻⁶ |
| Embodiment | E4 | 1 | 700 | 7.68 × 10⁻⁶ |
| Embodiment | E5 | 2 | 790 | 7.97 × 10⁻⁶ |
| Embodiment | E6 | 5 | 830 | 8.31 × 10⁻⁶ |
| Embodiment | E7 | 10 | 850 | 8.65 × 10⁻⁶ |
| Embodiment | E8 | 15 | 850 | 8.76 × 10⁻⁶ |
| Embodiment | E9 | 20 | 700 | 8.82 × 10⁻⁶ |
| Comparative | C3 | 30 | 350 | 9.25 × 10⁻⁶ |
| example | | | | |
| Comparative | C4 | 50 | 300 | 9.71 × 10⁻⁶ |
| example | | | | |

As seen from Table 1, it can be understood that the insulators in which the nanoparticles are moderately dispersed (sample E1-sample E9) show high transverse rupture strength compared to the insulator not containing the nanoparticles (sample C1), and the insulators whose nanoparticle contents are out of the range of the present invention (samples C2-C4).

Further, when a stress occurred in the gas sensor element due to flooding in a vehicle-mounted condition of the gas sensor element is obtained through simulation, a stress up to 350 MPa occurs in a condition of element temperature of 300° C. (see FIG. 11).

All the insulators of sample E1-sample ED fabricated in this example can exhibit large strength beyond 350 MPa. Therefore, it can be understood that sample E1-sample E9 are suitable for an insulator of a vehicle-mounted gas sensor element.

Further, sample E1-sample E9 showed thermal expansion coefficients which are about the same with sample C1 made of alumina (see Table 1). The insulator made of alumina (sample C1) is widely used as an insulator of a conventional gas sensor element, and sample E1-sample E9 whose thermal expansion coefficients are about the same as this sample C1 can be easily applied to the gas sensor element without largely changing the structure of the gas sensor element.

### Embodiment 3

This embodiment concerns a gas sensor element 3 in which the structure of the embodiment 1 shown in FIG. 1-FIG. 3 described in the foregoing is modified partly. To be more precise, there is adopted such a structure that the insulating layer 163, the insulator 191, the adhesion layer 162, and insulating print layers 200 and 201 consist primarily of alumina, and other insulators 15, 141, 142, 191, 195, 197, 161, 164, 165 and the solid electrolyte body 11 consist primarily of zirconia.

That is, the gas sensor element 3 of this embodiment includes the solid electrolyte body 11, insulators 15, 141, 142, 191, 195, 197, 163, 161, 162, 164, 165, pair of the electrodes 121, 131 formed such that the solid electrolyte body 11 is held therebetween, and heater 19. The solid electrolyte body 11 is made of partially stabilized zirconia. Further, the insulators 195, 163, 161, 162 are made of insulative composite material in which the nanoparticles 10 with a particle diameter equal to or smaller than 100 nm are dispersed in a principal component composed of insulative ceramics having electrical insulativity by 2 weight %.

Further, in this embodiment, the insulating printing layers 200, 201 are formed on the side of the heat generating element 181 and the lead section 182 of the insulators 191, 197. The insulating print layers 200, 201 are also insulators, and are made of insulative composite material in which the nanoparticles 10 with a particle diameter equal to or smaller than 100 nm are dispersed in a principal component composed of insulative ceramics having electrical insulativity by 2 weight %.

In this embodiment, the pair of the electrodes 121, 131 are the measured gas side electrode 121 facing the measured gas atmosphere, and the reference electrode 131 facing the reference gas atmosphere, respectively. The solid electrolyte body 11 is laminated with the gas-permeable insulator diffusion layer) 141 covering the measured gas side electrode 121, and the diffusion layer 141 is laminated with the gas-impermeable insulator (shield layer) 142. Further, although this embodiment is an embodiment of a one-cell type A/F sensor including the pair the electrodes 121, 131 formed such that the solid electrolyte body 11 is held therebetween, it may be applied to a two-cell type A/F sensor including another pair of electrodes formed such that a solid electrolyte body is held therebetween. Moreover, it may be applied to not only A/F sensors, but 0₂ sensors, NOₓ sensors, etc., as well.

In the following, explanation is made in detail.

The gas sensor element 3 of this embodiment is used incorporated in a gas sensor mounted on an exhaust system of a vehicle engine. This gas sensor measures oxygen concentration in an exhaust gas, and detects air-fuel ratio of the engine from a measured value, the air-fuel ratio being used for combustion control of the engine.

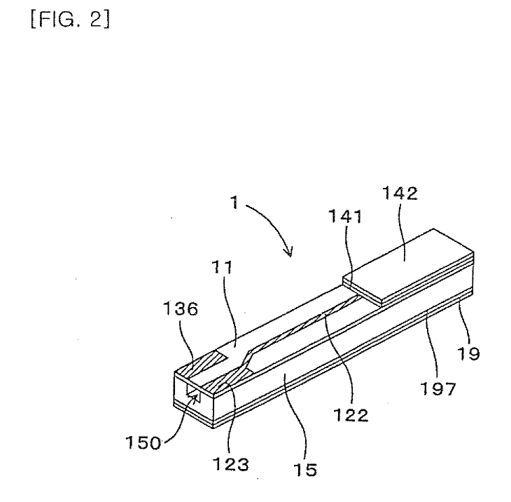

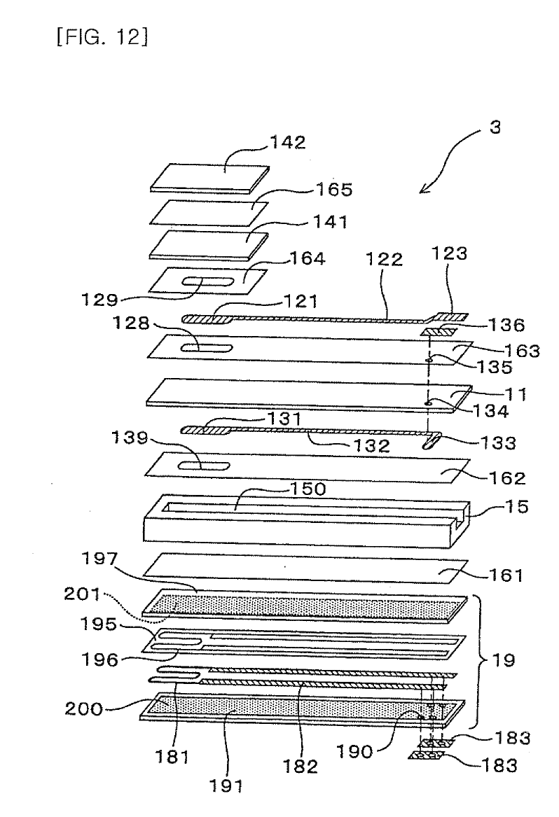

As shown in FIG. 12, and FIG. 2, FIG. 3 described in the foregoing, the gas sensor element 3 of this embodiment is structured by laminating the reference gas chamber forming plate (insulator) 15, solid electrolyte body 11, diffusion layer 141, and shield layer 142.

The reference gas chamber forming plate 15 includes a groove section 150 having a U-shaped cross section, which serves as a reference gas chamber into which a reference gas is introduced.

The solid electrolyte body 11, which includes the measured gas side electrode 121, and reference electrode 131, is provided with lead sections 122, 132 which electrically connect to these electrodes 121, 131.

Further, the diffusion layer 141 is laminated so as to cover the measured gas side electrode 121, and the shield layer 142 is laminated so as to cover the diffusion layer 141.

Further, the gas sensor element 3 of this embodiment is integrally provided with the ceramic heater 19 at a surface of the reference gas chamber forming plate 15 opposite to the solid electrolyte body 11.

The ceramic heater 19 is constituted by a heater sheet 191, a heat generating element 181 provided in the heater sheet 191, a lead section 182 supplying power to the heat generating element 181, and two heater insulating plates 195, 197 laminated so as to cover the heat generating element 181.

The heater insulating plate 195 has a window section 196. This window section 196, which has the same shape as the heat generating element 181 and the lead section 182 to be able to incorporate both of them, is provided to smooth unevenness when the heat generating element 181 and the lead section 182 are put between the heater sheet 191 and the heater insulating plate 197.

Further, the lead section 182 electrically connects to a terminal 183 through a through hole 190 provided in the heater sheet 191.

Between the heater insulating plate 197 and the reference gas chamber forming plate 15, between the reference gas chamber forming plate 15 and the solid electrolyte body 11, and between the diffusion layer 141 and the shield layer 142, there are intercalated adhesion layers 161, 162, 165, respectively. Further, the insulating layer 163 and the adhesion layer 164 are intercalated between the solid electrolyte body 11 and the diffusion layer 14.

The reference gas chamber forming plate 15, diffusion layer 141, heater sheet 191, heater insulating plates 195, 197, and the adhesion layers 161, 164, 165 are all insulators, and these insulators consisting primarily of zirconia as insulative ceramics.

Further, the insulating layer 163 and the adhesion layer 162 consist primarily of alumina as insulative ceramics.

Further, the porosity of the diffusion layer 141 is 14%.

In each of the insulators 15, 141, 142, 191, 195, 197, 161, 164, 165, the nanoparticles 10 with a particle diameter equal to or smaller than 10 nm are dispersed in a principal component composed of each insulative ceramics (zirconia) by about 2 weight %. Incidentally, in each of the insulators, commercially available alumina nanoparticles (particle diameter being about 10-50 cm) wee used as the nanoparticles 10.

Further, in the adhesion layer 162 and the insulating layer 163 as insulators, the nanoparticles 10 with a particle diameter equal to or smaller than 100 cm are dispersed in a principal component composed of each insulative ceramics (alumina) by about 2 weight %. Incidentally, commercially available zirconia nanoparticles (particle diameter being about 10-50 nm) was used as the nanoparticles 10 in the adhesion layer 162 and the insulating layer 163.

Further, the solid electrolyte body 11 is made of partially stabilized zirconia in which yttria is added to zirconia by 6 mol %. The solid electrolyte body 11 includes the reference electrode 131 facing the groove section 150 serving as the reference gas chamber, and the adhesion layer 162 includes a window 139 at a position facing the reference electrode 131. Further, the reference electrode 131 electrically connects to a terminal 136 through the lead section 132, an internal terminal 133, a conductive through hole 134 provided in the solid electrolyte body 11, and a conductive through hole 135 provided in the insulating layer 163.

The insulating layer 163, and the adhesion layer 164 include windows 128, 129 at positions facing the measured gas side electrode 121. Further, the measured gas side electrode 121 electrically connects to a terminal 123 through the lead section 122.

The output of the gas sensor element 3 can be obtained through the terminals 123, 136.

Further, as shown in FIG. 3, the windows 128, 129 provided in the insulating layer 163 and the adhesion layer 164 serve as a small chamber 127 housing the measured gas side electrode 121 by lamination. A measured gas is introduced into this small chamber 127 through the diffusion layer 141.

Next, explanation is made as to a method of manufacturing the gas sensor element 3 of this embodiment.

In the manufacturing method of this embodiment, a gas sensor element is manufactured by performing the nanoslurry preparation step, ion-conductive slurry preparation step, insulative slurry preparation step, insulative composite material preparation step, ion-conductive ceramics forming step, insulative composite material forming step, electrode print section forming step, and baking step.

To be more precise, a green sheet for the solid electrolyte body 11 is fabricated by the doctor blade method, or extrusion molding method. Subsequently, print sections for forming the measured gas side electrode 121, reference electrode 131, lead section 132, and internal terminal 133 are provided in this green sheet. Incidentally, the green sheet for the solid electrolyte body 11 is provided with the through hole 134 in advance.

An unbaked compact for the reference gas chamber forming plate 15 is made by injection molding, cutting fabrication, press molding, laminating fabrication of green sheets, etc. Further, green sheets for the heater sheet 191, shield layer 142, and diffusion layer 141 are fabricated by the doctor blade method, extrusion molding method, etc.

Further, the shield layer 142, and the diffusion layer 141 may be made of slurry.

Further, the green sheet for the heater sheet 191 is provided with a print section for the heat generating element 181 etc. The through hole 190 is also provided in advance.

Further, for the various adhesion layers 161, 162, 164, 165, and the insulating layer 163, a slurry for the adhesion layer or insulating layer is made, and printed to the green sheets. Those having the windows 129, 139, 128, are formed by screen printing using slurry, and the heater insulating plates 195, 197 are formed by screen printing using slurry as well.

Further, the insulating printing layers 200, 201 are formed on the side of the heat generating element 181 and the lead section 182 of the insulators 191, 197.

Further, the green sheet for the solid electrolyte body 11 is provided with print sections for forming the measured gas side electrode 121, lead section 122, and terminals 136 and 123, after being applied with slurry for the insulating layer 163,

Further, in case at least one of the shield layer 142 and the diffusion layer 141 is made by slurry, the adhesion layer 165 may be eliminated. Further, in case the diffusion layer 141 is made by slurry, it may be overlaid on the adhesion layer 164. That is, it is possible to form the adhesion layer 164 integrally with the diffusion layer 141.

Incidentally, the green sheets or slurry for forming the reference gas chamber forming plate 15, diffusion layer 141, shield layer 142, heater sheet 191, heater insulating plates 195, 197, and adhesion layers 116, 164, 165 were made by adding solvent such as alcohol such as ethanol, 2-butanol etc., acetic acid isoamyl alcohol, sorbitan trioleate (SPN), polyvinyl butyrate (PVB), benzyl butyl phthalate (BBP) into an insulative composite material in which the nanoparticles (alumina nanoparticles) 10 are dispersed in a principal component composed of insulative ceramics (zirconia) by 2 weight %. The green sheets were made by forming slurry (insulative 1 composite material slurry) in which the insulative ceramics and nanoparticles 10 are dispersed in a solvent. The insulative composite material slurry was prepared by mixing insulative ceramics slurry made by dispersing insulative ceramics in a solvent, and nanoparticle slurry prepared by dispersing nanoparticles in a solvent.

Further, the printing slurry for forming the insulating layer 163 and the adhesion layer 162 was made by adding solvent such as alcohol such as ethanol, 2-butanol etc., acetic acid isoamyl alcohol, sorbitan trioleate (SPN), polyvinyl butyrate (PVB), benzyl butyl phthalate (BBP) into insulative composite material in which the nanoparticles (zirconia nanoparticles) 10 are dispersed in a principal component composed of insulative ceramics (alumina) by 2 weight %.

The insulative composite material slurry in this case was prepared by mixing insulative ceramics slurry made by dispersing insulative ceramics in a solvent, and nanoparticle slurry prepared by dispersing nanoparticles in a solvent.

Further, the printing slurry for forming the insulating print layers 200, 201 was made by adding solvent such as alcohol such as ethanol, 2-butanol etc., acetic acid isoamyl alcohol, sorbitan trioleate (SPN), polyvinyl butyrate (PVB), benzyl butyl phthalate (BBP) into insulative composite material in which the nanoparticles (zirconia nanoparticles) 10 are dispersed in a principal component composed of insulative ceramics (alumina) by 2 weight %.

The insulative composite material slurry in this case was prepared by mixing insulative ceramics slurry made by dispersing insulative ceramics in a solvent, and nanoparticle slurry prepared by dispersing nanoparticles in a solvent.

Further, the green sheet for the solid electrolyte body was made by preparing slurry (ion-conductive ceramics slurry) by dispersing, into the solvents, ion-conductive ceramics made of partially stabilized zirconia in which yttria is added to zirconia by 6 mol %, and by forming this slurry.

Further, preparation of each slurry was performed by the high-pressure dispersion process by use of the high-pressure dispersion apparatus (high-pressure homogenizer).

As shown in FIG. 4 and FIG. 5, the high-pressure dispersion apparatus 4 includes the mixing dispersion section 42 in which the movable orifice 44 is provided so as to move up and down. The mixing dispersion section 42 is connected to a storage tank 43 by pipings e1, e2, e3. Further, the high-pressure dispersion apparatus 4 is provided with a high-pressure pump 41 for driving the movable orifice 44. The high-pressure pump 41 and the movable orifice 44 are driven by compressed air shown by the arrows d1, d2.

In the high-pressure dispersion process, each slurry is introduced from the piping e1 of the high-pressure dispersion apparatus 4. The introduced slurry is pressure-fed to the mixing dispersion section 42, and collides with a front end (collision section 440) of the movable orifice 44 under high pressure (200 MPa). At this time, the slurry forms a high-speed flow, and flocculated portions in the slurry are broken by shock formed by this high-speed flow, enabling them to disperse to a primary particle state. Further, at the time of high-pressure feeding, mechanical shear force is applied to the slurry, and more uniform dispersion can be promoted by this shear force.

After collision with the collision section 440, the slurry diverges, flows out from two exists 421, 422, converges at the piping e3, and returns to the storage tank 43. It is possible to cause the slurry to circulate again from the storage tank 43 to the mixing dispersion section 42 through the pipings e2 and e1.

Each of the green sheets made as above were laminated in the order shown in FIG. 1, and pressed, as a consequence, they adhered mutually by the adhesiveness (glutinosity) of the adhesion layers 161, 162, 164, 165, and an unbaked laminated body was obtained. This unbaked laminated body was baked by being heated up to 1470° C.

Thereafter, by cooling down from 1470° C. to room temperature, the gas sensor element 3 of this embodiment was obtained.

Functions and effects of this embodiment are explained.

In the gas sensor element 3 of this embodiment, the reference gas chamber forming plate 15, diffusion layer 141, shield layer 142, heater sheet 191, heater insulating plates 195, 197, and adhesion layers 161, 164, 165 are insulators made of insulative composite material. That is, the insulator consists primarily of zirconia in which the nanoparticles 10 with a particle diameter equal to or smaller than 100 nm are dispersed.

Further, the insulating layer 163, and the adhesion layer 162 are insulators made of insulative composite material. That is, the insulators consist primarily of alumina in which the nanoparticles 10 with a particle diameter equal to or smaller than 100 nm are dispersed.

Further, the insulating print layers 200, 201 consist primarily of alumina in which the nanoparticles 10 with a particle diameter equal to or smaller than 100 nm are dispersed.

Accordingly, the insulators 15, 141, 142, 191, 195, 197, 161, 162, 163, 164, 165, 200, 201 can withstand large stress exceeding 350 MPa, for example, and can exhibit excellent strength. Therefore, even if the gas sensor element is flooded, and large stresses occur in the insulators, it is possible to prevent the insulators 15, 141, 142, 191, 195, 197, 161, 162, 163, 164, 165, 200, 201 from being broken. Accordingly, it is possible to suppress that accuracy of measurement of concentrations of various kinds of gas by the gas sensor element 3 is lost.

In particular, in the gas sensor element 3 of this embodiment, the insulative composite material makes the insulating layer 163, adhesion layers 164, 165, diffusion layer 141 and shield layer 142 which directly contact, during operation, a gas such as the exhaust gas, the reference gas chamber forming plate 15 and the adhesion layer 162 which contact the reference gas, and the heater sheet 191 and the heater insulating plates 195, 197 of the heater 19 which easily undergo temperature change and contact the external atmospheric air. Accordingly, even if portions where various gases such as the exhaust gas, atmospheric air and reference gas are in contact with the various insulators 15, 141, 142, 191, 195, 197, 161, 162, 163, 164, 165, 200, 201 are flooded, and large stresses occur, since the various insulators exhibit excellent strength as described above, it is possible to prevent occurrence of fracture or breakage.

Further, in the various insulators 15, 141, 142, 191, 195, 197, 161, 164, 165, the nanoparticles 10 are dispersed in the principal component composed of zirconia by 2 weight %. Therefore, the insulativity of the insulators 15, 141, 142, 191, 195, 197, 161, 164, 165 are sufficiently assured.

Further, in the insulators 162, 163, 200, 201, the nanoparticles 10 are dispersed in the principal component composed of alumina by 2 weight %. Therefore, the insulativity of the insulators 162, 163, 200, 201 are sufficiently assured.

Accordingly, the gas sensor element 3 can exhibit excellent strength while assuring the function as a gas sensor element. Therefore, if the gas sensor element 3 is applied with large stress, occurrence of breakage such as fracture etc. can be prevented. Thence, the gas sensor element 3 can perform correct detection, and is excellent in reliability.

1. A gas sensor element comprising:
a solid electrolyte body consisting primarily of ion-conductive ceramics;
an insulator consisting primarily of insulative ceramics; and
a pair of electrodes formed such that at least a part of the solid electrolyte body is held therebetween;
said gas sensor element satisfying at least one of the following requirements (a) and (b).
(a) At least a part of the solid electrolyte body is made of ion-conductive composite material in which nanoparticles with a particle diameter equal to or smaller than 100 nm (nanometer, hereinafter omitted) are dispersed in a principal component composed of the ion-conductive ceramics by 0.1-20 weight %.
(b) At least a part of the insulator is made of insulative composite material in which nanoparticles with a particle diameter equal to or smaller than 100 nm are dispersed in a principal component composed of the insulative ceramics by 0.1-20 weight %.

2. The gas sensor element according to claim 1, wherein the ion-conductive ceramics is made of partially stabilized zirconia in which a stabilizer is added to a principal component composed of zirconia, and the insulative ceramics is made of alumina.

3. The gas sensor element according to claim 1, wherein the nanoparticles are made of one or more kinds selected from alumina, zirconia, partially stabilized zirconia, and the stabilizer.

4. The gas sensor element according to claim 1, wherein at least the solid electrolyte body located at a position to be in contact with a gas introduced into the gas sensor element, or atmospheric air is made of the ion-conductive composite material.

5. The gas sensor element according to claim 1, wherein at least the insulator located at a position to be in contact with a gas introduced into the gas sensor element, or atmospheric air is made of the insulative composite material.

6. A method of manufacturing a gas sensor element including a solid electrolyte body made of ion-conductive composite material in which nanoparticles with a particle diameter equal to or smaller than 100 nm are dispersed in a principal component composed of ion-conductive ceramics by 0.1-20 weight %, an insulator consisting primarily of insulative ceramics, and a pair of electrodes formed such that at least a part of the solid electrolyte body is held therebetween, said method comprising:
a nanoslurry preparation step of preparing nanoparticle slurry by dispersing nanoparticles with a particle diameter equal to or smaller than 100 nm in a solvent;
an ion-conductive slurry preparation step of preparing ion-conductive ceramics slurry by dispersing ion-conductive ceramics in a solvent;
an ion-conductive composite material preparation step of preparing ion-conductive composite material slurry by mixing the nanoparticle slurry and the ion-conductive ceramics slurry at a mixing ratio of 0.1-20 weight parts of the nanoparticles to 100 parts of a total of the nanoparticles and the ion-conductive ceramics;
an ion-conductive composite material forming step of making an ion-conductive composite material compact by forming the on-conductive composite material slurry;
an electrode print section forming step of forming a pair of electrode print sections such that at least a part of the ion-conductive composite material compact is held therebetween;
an insulative slurry preparation step of preparing insulative ceramics slurry by dispersing insulative ceramics in a solvent;
an insulative ceramics' forming step of making an insulative ceramics compact by forming the insulative ceramics slurry; and
a baking step of making the gas sensor element by integrally baking the ion-conductive composite material compact and the insulative ceramics compact.

7. A method of manufacturing a gas sensor element including a solid electrolyte body made of ion-conductive composite material in which nanoparticles with a particle diameter equal to or smaller than 100 nm are dispersed in a principal component composed of ion-conductive ceramics by 0.1-20 weight %, an insulator consisting primarily of insulative ceramics, and a pair of electrodes formed such that at least a part of the solid electrolyte body is held therebetween, said method comprising:
a nanoslurry preparation step of preparing nanoparticle slurry by dispersing nanoparticles with a particle diameter equal to or smaller than 100 nm in a solvent;
an ion-conductive slurry preparation step of preparing ion-conductive ceramics slurry by dispersing ion-conductive ceramics in a solvent;
an ion-conductive composite material preparation step of preparing ion-conductive composite material slurry by mixing the nanoparticle slurry and the ion-conductive ceramics slurry at a mixing ratio of 0.1-20 weight parts of the nanoparticles to 100 parts of a total of the nanoparticles and the ion-conductive ceramics;
an ion-conductive composite material forming step of making an ion-conductive composite material compact by forming the ion-conductive composite material slurry;
a baking step of making the solid electrolyte body by baking the ion-conductive composite material compact;
an electrode forming step of forming a pair of electrodes such that at least a part of the solid electrolyte body is held therebetween;
an insulative slurry preparation step of preparing insulative ceramics slurry by dispersing insulative ceramics in a solvent;
an insulative ceramics body forming step of forming an insulative ceramics body integrally with the solid electrolyte body by baking the insulative ceramics slurry onto the solid electrolyte body, or by plasma-spraying the insulative ceramics slurry onto the solid electrolyte body.

8. The method of manufacturing a gas sensor element according to claim 6, wherein, in each of the nanoslurry preparation step, ion-conductive slurry preparation step, insulative slurry preparation step, and ion-conductive composite material preparation step, a high-pressure dispersion apparatus including a flow channel serving as a passage of each slurry, and a collision section disposed midway of the flow channel is used to perform a high-pressure dispersion process where each slurry is pressure-fed to the flow channel of the high-pressure dispersion apparatus, to cause each slurry to disperse colliding with the collision section under pressure of 10-400 MPa.

9. The method of manufacturing a gas sensor element according to claim 8, wherein the high-pressure dispersion device includes a mixing dispersion section in which a movable orifice is provided so as to move up and down, and perform the high-pressure dispersion process by using, as the collision section, a front end portion of the movable orifice exposed to the inside of the mixing dispersion section.

10. The method of manufacturing a gas sensor element according to claim 6, wherein, in each of the nanoslurry preparation step, ion-conductive slurry preparation step, insulative slurry preparation step, and ion-conductive composite material preparation step, there is performed an agitating dispersion process in which each slurry is dispersed while being agitated to be applied with a shear force.

11. The method of manufacturing a gas sensor element according to claim 10, wherein the agitating dispersion process is performed by agitating each slurry in an agitation tank including a closed pressure-tight container, and rotary vanes mounted on a rotating shaft provided in the closed pressure-tight container.

12. The method of manufacturing a gas sensor element according to claim 6, wherein one or more kinds selected from the nanoparticle slurry, ion-conductive ceramics slurry, ion-conductive composite material slurry, and insulative ceramics slurry is dispersed by applying ultrasonic sound thereto.

13. A method of manufacturing a gas sensor element including a solid electrolyte body consisting primarily of ion-conductive ceramics, an insulator made of an insulative composite material in which nanoparticles with a particle diameter equal to or smaller than 100 nm are dispersed in a principal component composed of ion-conductive ceramics by 0.1-20 weight %, and a pair of electrodes formed such that at least a part of the solid electrolyte body is held therebetween, said method comprising:
an ion-conductive slurry preparation step of preparing ion-conductive ceramics slurry by dispersing ion-conductive ceramics in a solvent;
an ion-conductive ceramics forming step of making an ion-conductive ceramics compact by forming the ion-conductive ceramics slurry;
an electrode print section forming step of forming a pair of electrode print sections such that at least a part of the ion-conductive ceramics compact is held therebetween;
a nanoslurry preparation step of preparing nanoparticle slurry by dispersing nanoparticles with a particle diameter equal to or smaller than 100 nm in a solvent;
an insulative slurry preparation step of preparing insulative ceramics slurry by dispersing insulative ceramics in a solvent;
an insulative composite material preparation step of preparing insulative composite material slurry by mixing the nanoparticle slurry and the insulative ceramics slurry at a mixing ratio of 0.1-20 weight parts of the nanoparticles to 100 parts of a total of the nanoparticles and the insulative ceramics; and
an insulative composite material forming step of making an insulative composite material compact by forming the insulative composite material slurry; and
a baking step of making the gas sensor element by integrally baking the ion-conductive ceramics compact and the insulative composite material compact.

14. A method of manufacturing a gas sensor element including a solid electrolyte body consisting primarily of ion-conductive ceramics, an insulator made of an insulative composite material in which nanoparticles with a particle diameter equal to or smaller than 100 nm are dispersed in a principal component composed of ion-conductive ceramics by 0.1-20 weight %, and a pair of electrodes formed such that at least a part of the solid electrolyte body is held therebetween, said method comprising:
an ion-conductive slurry preparation step of preparing ion-conductive ceramics slurry by dispersing ion-conductive ceramics in a solvent;
an ion-conductive ceramics forming step of making an ion-conductive ceramics compact by forming the ion-conductive ceramics slurry;
a baking step of making the solid electrolyte body by baking the ion-conductive ceramics compact;
an electrode forming step of forming a pair of electrodes such that at least a part of the solid electrolyte body is held therebetween;
a nanoslurry preparation step of preparing nanoparticle slurry by dispersing nanoparticles with a particle diameter equal to or smaller than 100 nm in a solvent;
an insulative slurry preparation step of preparing insulative ceramics slurry by dispersing insulative ceramics in a solvent;
an insulative composite material preparation step of preparing insulative composite material slurry by mixing the nanoparticle slurry and the insulative ceramics slurry at a mixing ratio of 0.1-20 weight parts of the nanoparticles to 100 parts of a total of the nanoparticles and the insulative ceramics; and
an insulative ceramics body forming step of forming an insulative ceramics body integrally with the solid electrolyte body by baking the insulative composite material slurry onto the solid electrolyte body, or by plasma-spraying the insulative composite material slurry onto the solid electrolyte body.

15. The method of manufacturing a gas sensor element according to claim 13, wherein, in each of the nanoslurry preparation step, ion-conductive slurry preparation step, insulative slurry preparation step, and insulative composite material preparation step, a high-pressure dispersion apparatus including a flow channel serving as a passage of each slurry, and a collision section disposed midway of the flow channel is used to perform a high-pressure dispersion process where each slurry is pressure-fed to the flow channel of the high-pressure dispersion apparatus, to cause each slurry to disperse colliding with the collision section under pressure of 10-400 MPa.

16. The method according to claim 15, wherein the high-pressure dispersion apparatus includes a mixing dispersion section in which a movable orifice is provided so as to move up and down, and perform the high-pressure dispersion process by using, as the collision section, a front end portion of the movable orifice exposed to the inside of the mixing dispersion section.

17. The method of manufacturing a gas sensor element according to claim 13, wherein, in each of the nanoslurry preparation step, ion-conductive slurry preparation step, insulative slurry preparation step, and insulative composite material preparation step, there is performed an agitating dispersion process in which each slurry is dispersed while being agitated to be applied with a shear force.

18. The method of manufacturing a gas sensor element according to claim 17, wherein the agitating dispersion process is performed by agitating each slurry in an agitation tank including a closed pressure-tight container, and rotary vanes mounted on a rotating shaft provided in the closed pressure-tight container.

19. The method of manufacturing a gas sensor element according to claim 13, wherein one or more kinds selected from the ion-conductive ceramics slurry, nanoparticle slurry, insulative ceramics slurry, and insulative composite material slurry is dispersed by applying ultrasonic sound thereto.

20. A method of manufacturing a gas sensor element including a solid electrolyte body made of an ion-conductive composite material in which first nanoparticles with a particle diameter equal to or smaller than 100 nm are dispersed in a principal component composed of ion-conductive ceramics by 0.1-20 weight %, an insulator made of insulative composite material in which second nanoparticles with a diameter equal to or smaller than 100 nm are dispersed in a principal component composed of insulative ceramics by 0.1-20 weight %, and a pair of electrodes formed such that at least a part of the solid electrolyte body is held therebetween, said method comprising:
a first nanoslurry preparation step of preparing first nanoparticle slurry by dispersing first nanoparticles with a particle diameter equal to or smaller than 100 nm in a solvent;
an ion-conductive slurry preparation step of preparing ion-conductive ceramics slurry by dispersing ion-conductive ceramics in a solvent;
an ion-conductive composite material preparation step of preparing ion-conductive composite material slurry by mixing the first nanoparticle slurry and the ion-conductive ceramics slurry at a mixing ratio of 0.1-20 weight parts of the first nanoparticles to 100 parts of a total of the first nanoparticles and the ion-conductive ceramics;
an ion-conductive composite material forming step of making an ion-conductive composite material compact by forming the on-conductive composite material slurry;
an electrode print section forming step of forming a pair of electrode print sections such that at least a part of the ion-conductive composite material compact is held therebetween;
a second nanoslurry preparation step of preparing second nanoparticle slurry by dispersing second nanoparticles with a particle diameter equal to or smaller than 100 nm in a solvent;
an insulative slurry preparation step of preparing insulative ceramics slurry by dispersing insulative ceramics in a solvent;
an insulative composite material preparation step of making insulative composite material slurry by mixing the second nanoparticle slurry and the insulative ceramics slurry at a mixing ratio of 0.1-20 weight parts of the second nanoparticles to 100 parts of a total of the second nanoparticles and the insulative ceramics; and
an insulative composite material forming step of making an insulative composite material compact by forming the insulative composite material slurry; and
a baking step of making the gas sensor element by integrally baking the ion-conductive composite material compact and the insulative composite material compact.

21. A method of manufacturing a gas sensor element including a solid electrolyte body made of an ion-conductive composite material in which first nanoparticles with a particle diameter equal to or smaller than 100 nm are dispersed in a principal component composed of ion-conductive ceramics by 0.1-20 weight %, an insulator made of insulative composite material in which second nanoparticles with a diameter equal to or smaller than 100 nm are dispersed in a principal component composed of insulative ceramics by 0.1-20 weight %, and a pair of electrodes formed such that at least a part of the solid electrolyte body is held therebetween, said method comprising:
a first nanoslurry preparation step of preparing first nanoparticle slurry by dispersing first nanoparticles with a particle diameter equal to or smaller than 100 nm in a solvent;
an ion-conductive slurry preparation step of preparing ion-conductive ceramics slurry by dispersing ion-conductive ceramics in a solvent;
an ion-conductive composite material preparation step of preparing ion-conductive composite material slurry by mixing the first nanoparticle slurry and the ion-conductive ceramics slurry at a mixing ratio of 0.1-20 weight parts of the first nanoparticles to 100 parts of a total of the first nanoparticles and the ion-conductive ceramics;
an ion-conductive composite material forming step of making an ion-conductive composite material compact by forming the on-conductive composite material slurry;
a baking step of making the solid electrolyte body by baking the ion-conductive composite material compact;
an electrode forming step of forming a pair of electrodes such that at least a part of the solid electrolyte body is held therebetween;
a second nanoslurry preparation step of preparing second nanoparticle slurry by dispersing second nanoparticles with a particle diameter equal to or smaller than 100 nm in a solvent;
an insulative slurry preparation step of preparing insulative ceramics slurry by dispersing insulative ceramics in a solvent;
an insulative composite material preparation step of preparing insulative composite material slurry by mixing the second nanoparticle slurry and the insulative ceramics slurry at a mixing ratio of 0.1-20 weight parts of the second nanoparticles to 100 parts of a total of the second nanoparticles and the insulative ceramics; and
an insulative ceramics body forming step of forming an insulative ceramics body integrally with the solid electrolyte body by baking the insulative composite material slurry onto the solid electrolyte body, or by plasma-spraying the insulative composite material slurry onto the solid electrolyte body.

22. The method of manufacturing a gas sensor element according to claim 20, wherein, in each of the first nanoslurry preparation step, ion-conductive slurry preparation step, second nanoslurry preparation step, insulative slurry preparation step, ion-conductive composite material preparation step, and insulative composite material preparation step, a high-pressure dispersion apparatus including a flow channel serving as a passage of each slurry, and a collision section disposed midway of the flow channel is used to perform a high-pressure dispersion process where each slurry is pressure-fed to the flow channel of the high-pressure dispersion apparatus, to cause each slurry to disperse colliding with the collision section under pressure of 10-400 MPa.

23. The method according to claim 22, wherein the high-pressure dispersion apparatus includes a mixing dispersion section in which a movable orifice is provided so as to move up and down, and perform the high-pressure dispersion process by using, as the collision section, a front end portion of the movable orifice exposed to the inside of the mixing dispersion section.

24. The method of manufacturing a gas sensor element according to claim 20, wherein, in each of the first nanoslurry preparation step, ion-conductive slurry preparation step, second nanoslurry preparation step, insulative slurry preparation step, ion-conductive composite material preparation step, and insulative composite material preparation step, there is performed an agitating dispersion process in which each slurry is dispersed while being agitated to be applied with a shear force.

25. The method of manufacturing a gas sensor element according to claim 24, wherein the agitating dispersion process is performed by agitating each slurry in an agitation tank including a closed pressure-tight container, and rotary vanes mounted on a rotating shaft provided in the closed pressure-tight container.

26. The method of manufacturing a gas sensor element according to claim 20, wherein one or more kinds selected from the ion-conductive ceramics slurry, first nanoparticle slurry, ion-conductive composite material slurry, insulative ceramics slurry, second nanoparticle slurry, and insulative composite material slurry is dispersed by applying ultrasonic sound thereto.
